(19) United States
(12) Patent Application Publication
(10) Pub. No.: US 2015/0232340 A1
(43) Pub. Date: Aug. 20, 2015

(54) Microporous/Mesoporous Carbon

(71) Applicant: The Board of Trustees of the Leland Stanford Junior University, Palo Alto, CA (US)

(72) Inventors: Zhenan Bao, Stanford, CA (US); John To, Stanford, CA (US); Jiajun He, Stanford, CA (US); Jennifer Wilcox, Half Moon Bay, CA (US); Jianguo Mei, West Lafayette, IN (US)

(21) Appl. No.: 14/701,322

(22) Filed: Apr. 30, 2015

Related U.S. Application Data
(63) Continuation-in-part of application No. 14/531,584, filed on Nov. 3, 2014.
(60) Provisional application No. 61/898,950, filed on Nov. 1, 2013.

(51) Int. Cl. C01B 31/04; B01J 20/20

(52) U.S. Cl. CPC C01B 31/04; B01J 20/20

(57) ABSTRACT

Hierarchically porous graphitic (HPG) carbon is provided via improved methods. The first approach is based on forming a 3-D polymer network from a first precursor and a second precursor and carbonizing it. The carbon in the resulting carbon structure comes from the first precursor, while the second precursor volatizes to form the pores. However, the second precursor is temperature resistant, such that carbonization of the first precursor is underway when the second precursor volatizes. The second approach is based on forming a structured polymer from first and second precursors. More specifically, the second precursor forms a second polymer having a micelle structure and the first precursor forms a first polymer that coats the micelle structure of the second polymer. The structured polymer is carbonized. Here also the carbon in the resulting carbon structure comes from the first precursor, while the second precursor volatizes to form the pores.

### CROSS REFERENCE TO RELATED APPLICATIONS

This application is a continuation in part of U.S. Ser. No. 14/531,584, filed on Nov. 3, 2014 and hereby incorporated by reference in its entirety. Application Ser. No. 14/531,584 claims the benefit of U.S. provisional patent application 61/898,950, filed on Nov. 1, 2013, and hereby incorporated by reference in its entirety.

### FIELD OF THE INVENTION

This invention relates to fabrication of porous carbon.

### BACKGROUND

Porous carbon and heteroatom-containing porous carbon has been investigated in connection with various applications for some time, such as energy storage devices, CO₂ capture, gas purification and separation, catalysis, water purification and odor removal, to name a few. However, it remains challenging to economically fabricate porous carbon having fully controlled properties. For example, fabrication of porous carbon from biological starting materials can be relatively inexpensive, but it can be difficult to control the process results. Another approach is the use of templates to give more precise control over the pores in the porous carbon. However, such template approaches tend to be difficult and therefore costly. Accordingly, it would be an advance in the art to provide improved methods for making porous carbon.

### SUMMARY

This work has two aspects, which involve two different ways to provide hierarchically porous graphitic (HPG carbon).

In the first aspect, an exemplary method includes the following steps: 1) providing a first precursor that includes one or more aromatic monomers; 2) providing a second precursor; 3) forming a 3-D polymer network from the first precursor and the second precursor, where the second precursor provides cross linking of one or more polymers derived from the first precursor; 4) drying the 3-D polymer network to provide a dried structure; and 5) carbonizing the dried structure to provide a porous carbon structure, where carbon of the porous carbon structure is provided at least in part by carbonization of the first precursor, where pores of the porous carbon structure are provided at least in part by volatilization of the second precursor, and wherein volatilization of the second precursor occurs at least in part when the dried structure is partially carbonized.

In other words, the second precursor is relatively temperature resistant, such that it does not volatize completely before the dried structure is carbonized. Since it remains in place (at least partially) during the carbonization, it helps to prevent pores from collapsing as they are being formed during carbonization. This point can be more clearly appreciated by considering the opposite case, where the second precursor were to be completely volatized when the first precursor starts to carbonize. In this (undesirable) situation, the mechanical support from the cross-linking provided by the second precursor would not be present at a point in fabrication where little or no carbon is present to provide alternative structural support. The result would be reduced porosity of the resulting carbon structure.

The porous carbon structure resulting from the above-described method of aspect #1 can be activated to further increase its porosity. If done, such activation is preferably performed at a temperature of 1200° C. or less, more preferably 1000° C. or less, even more preferably 800° C. or less. Both the aromatic monomers and the second crosslinker can include one or more heteroatoms (i.e. non carbon or hydrogen atoms) to provide functional groups in the porous carbon structure. The aromatic monomers can form one or more conjugated polymers. The porous carbon structure is preferably at least partly graphitic. The 3-D polymer network can be formed via covalent or non-covalent interactions between the first precursor and the second precursor. Such non-covalent interactions can include hydrogen bonding, metal-ligand bonding, and/or ionic bonding. Suitable materials for the second precursor include, but are not limited to: phytic acid, phytic acid derivatives, inositol phosphates, inositol phosphate derivatives, phosphonic acid derivatives containing two or more phosphonic acids, boroxine, tetrakis[phenyl-4-boryl(dihydroxy)]methane, boronic acid derivatives containing two or more boronic acids, and metallo or H,H-phthalocyanine-tetrasulfonic acid, and sufonic acid derivatives containing two or more sufonic acids.

In the second aspect, an exemplary method includes the following steps: 1) providing a first precursor having an A-B structure with one or more B groups attached to an A backbone, where A is a hydrophobic aromatic monomer or a chemical combination of aromatic monomers selected from the group consisting of: pyrrole, thiazole, pyridine, aniline, thiophene, furan and their derivatives, and where B is a functional group selected from the group consisting of: carboxylic acid group (—COOH), hydroxyl group (—OH), amine group (—NH2), nitrile group (—CN), sulphonic acid group (—SO3H), phosphonic acid group (—PO4H), boronic acid (—BO2H2), amide group (—C(═O)—NH—), and amino acid group (—CH(NH2)-COOH); 2) providing a second precursor; 3) forming a structured polymer from the first precursor and the second precursor, where a structure of the structured polymer is determined by a micelle structure formed by the second precursor, and wherein a first polymer formed by the first precursor is disposed to coat the micelle structure formed by the second precursor; and 4) carbonizing the structured polymer to provide a porous carbon structure, wherein carbon of the porous carbon structure is provided at least in part by carbonization of the first polymer, and wherein pores of the porous carbon structure are provided at least in part by volatilization of the second precursor.

The B groups can be hydrophilic and in such cases a solvent used to form the micelle structure of the second polymer is also hydrophilic. Alternatively, the B groups can be hydrophobic and in such cases a solvent used to form the micelle structure of the second polymer is also hydrophobic. The porous carbon structure resulting from the above-described method of aspect #2 can be activated to further increase its porosity. If done, such activation is preferably performed at a temperature of 1200° C. or less, more preferably 1000° C. or less, even more preferably 800° C. or less. The aromatic monomers can include one or more heteroatoms to provide functional groups in the porous carbon structure. The aromatic monomers can form one or more conjugated polymers. The porous carbon structure is preferably at least partly graphitic.

The detailed description below provides exemplary experimental demonstrations according to these principles. In section B (relating to the first aspect), the first precursor is aniline and the second precursor is phytic acid. In section C (relating to the second aspect), the first precursor is a 4-(pyrrol-1-yl)butanoic acid (Py-COOH) monomer, and the second precursor is triblock copolymer Pluronic® P-123. However, practice of the invention is not restricted to these specific materials. The general ideas of having the second precursor be temperature resistant to provide mechanical support during carbonization (first aspect), and of using a micelle structure to effectively provide a template for pores (second aspect), can be applicable to other choices of materials, some of which are specifically indicated above. Furthermore, these aspects can be practiced individually or in combination.

Further examples of suitable materials follow. For the first aspect, suitable materials for the first precursor include, but are not limited to: pyrrole, pyrrole derivatives, aniline, aniline derivatives, thiophene, thiophene derivatives, PEDOT:PSS (poly(3,4-ethylenedioxythiophene) polystyrene sulfonate), PEDOT:PSS derivatives, phenol formaldehyde, melamine formaldehyde, conjugated polymers with positive charges under acidic conditions, and melamine resol with negative charges. Suitable materials for the second precursor include, but are not limited to: triacid, phytic acid, tannic acid, polystyrene sulfonate, sulfonated graphene oxide, alginic acid, phosphorous acid, sulfonic acid, boronic acid and crosslinkers or salts with an opposite charge that interact electrostatically with the charged polymer formed by the first precursor.

For the second aspect, suitable materials for the first precursor include but are not limited to: pyrrole, pyrrole derivatives, aniline, aniline derivatives, thiophene, thiophene derivatives, PEDOT:PSS, and PEDOT:PSS derivatives. Suitable materials for the second precursor include, but are not limited to: CTAB (cetyltrimethylammonium bromide), Pluronic® series compositions, Tween® series compositions, and Triton® series compositions.

### DEFINITIONS

1) A conjugated structure has alternating double bonds and single bonds
2) An aromatic monomer includes one or more covalently bonded planar rings in its chemical structure with a number of n delocalized electrons that is even, but not a multiple of 4.
3) Phytic acid has the International Union of Pure and Applied Chemistry (IUPAC) name (1R,2R,3S,4S,5R,6S)-cyclohexane-1,2,3,4,5,6-hexayl hexakis[dihydrogen(phosphate)]. It includes six phosphate groups.
4) Inositol is a six-fold alcohol of cyclohexane, with formula C₆H₁₂O₆.
5) Inositol phosphates are obtained by substitution of phosphate groups for one or more of the —OH groups in inositol. Examples include inositol bisphosphate (2 substitutions), inositol trisphosphate (3 substitutions), inositol pentakisphosphate (5 substitutions) and phytic acid (6 substitutions).
6) A phytic acid derivative is obtained by substitution of other chemical groups for one to five of the phosphate groups in phytic acid. An inositol phosphate derivative is obtained by substitution of other chemical groups for some but not all of the phosphate groups in the inositol phosphate.
7) A graphitic carbon structure is wholly or partially configured as weakly bonded planar layers of carbon atoms arranged in a honeycomb lattice.
8) Pyrrole has the IUPAC name 1H-Pyrrole and its formula is C₄H₄NH.
9) Thiazole has the IUPAC name of 1,3-Thiazole and its formula is C₃H₃NS.
10) Pyridine is standard IUPAC nomenclature and its formula is C₅H₅N.
11) Aniline has the IUPAC name phenylamine and its formula is C₆H₅NH₂.
12) Thiophene is standard IUPAC nomenclature and its formula is C₄H₄S.
13) Furan is standard IUPAC nomenclature and its formula is C₄H₄O.
14) Derivatives of any of 8-13 above are obtained by substitution of other chemical groups for one or more of the hydrogen atoms in these compounds.
15) A micelle structure is a structure formed by surfactant molecules dispersed in a liquid.

### BRIEF DESCRIPTION OF THE DRAWINGS

FIGS. 1A-C show a synthesis overview for the first aspect of the invention.

FIGS. 2A-B show porosity and composition of 3D HPG carbon.

FIGS. 3A-F show structure and morphology of 3D HPG carbon.

FIG. 4A-D show experimental results relating to 3D HPG carbon.

FIGS. 5A-F show HPG carbon supercapacitor performance in 0.5 M H₂SO₄ aqueous electrolyte.

FIGS. 6A-C show electrochemical performance of 3D HPG carbon for Li—S batteries.

FIG. 7 is an SEM image of dry PANi polymeric framework.

FIGS. 8A-F are TEM images of carbonized PANi polymers at different temperatures.

FIG. 9 shows the CO₂ adsorption/desorption isotherm of 3D HPG carbon.

FIG. 10 shows pore size distribution of a commercial porous carbon.

FIGS. 11A-B show N₂ adsorption/desorption isotherms and pore size distribution of a commercial porous carbon.

FIGS. 12A-D are further HRTEM images of 3D HPG carbon.

FIGS. 13A-B show XPS results relating to 3D HPG carbon.

FIG. 14 shows the XPS spectra of the polymer framework.

FIG. 15 shows the XPS spectra of the carbonized polymer framework.

FIGS. 16A-D show HPG carbon-based supercapacitor performance in organic 1 M TEABF₄/ACN electrolyte.

FIG. 17 shows long-term cycling stability of symmetric HPG carbon-based supercapacitors in 0.5 M H₂SO₄ electrolyte.

FIG. 18 is a Nyquist plot of a HPG carbon-based symmetric supercapacitor cycled before and after 10000 cycles in 0.5 M H₂SO₄.

FIG. 19 is a schematic showing the structure of the Li-polysulfide cell using 3D HPG carbon as the sulfur host.

FIGS. 20A-B show electrochemical performance of 3D HPG carbon in Li—S batteries.

FIG. 21 shows Nyquist plots of a HPG carbon-based Li—S battery at different cycling status.

FIG. 22 is a table that gives a summary of different porous carbons synthesized at various conditions.

FIG. 23 is a table showing the price of various types of activated carbon.

FIG. 24A shows a synthesis overview for the second aspect of the invention.

FIGS. 24B-E are SEM and TEM images relating to the synthesis of FIG. 24A.

FIGS. 25A-D show characterization and gas sorption behaviors of SU-MC1 porous carbon.

FIGS. 26A-D show characterization and gas sorption behaviors of SU-MAC1 porous carbon.

FIG. 27 shows scanning electron microscopy of SU-MC1 porous carbon.

FIG. 28 shows X-ray diffraction of SU-MC1 porous carbon.

FIGS. 29A-D show initial slopes of CO₂ and N₂ isotherms for the SU-MC1 and SU-MAC1 porous carbon samples.

FIG. 30 shows isosteric heat of CO₂ adsorption onto SU-MC1 and SU-MAC1.

FIG. 31 shows N₂ adsorption and desorption isotherms of SU-MAC1 at 77 K.

FIGS. 32A-B show N₂ adsorption and desorption isotherms at 77 K for two commercial porous carbon samples.

FIG. 33 shows CO₂ and N₂ adsorption isotherms of SU-MAC1 in comparison with the commercial porous carbon samples.

FIG. 34 shows the experimental setup for dynamic column breakthrough experiments.

FIG. 35 shows multi-cycle dynamic column adsorption capacity of CO₂ by SU-MC1.

FIGS. 36A-C show normalized CO₂ composition detected by mass spectrometry in the dynamic column breakthrough experiments for various samples and humidity conditions.

FIG. 37 shows normalized CO₂ composition detected by mass spectrometry for CO₂ breakthrough on SU-MAC1 with acidic impurities.

FIG. 38 is an ¹H NMR spectrum of 4-(Pyrrol-1-yl)butanoic acid.

FIG. 39 is a table of textual properties and CO₂ capture performances of SU-MC1 and SU-MAC1 in comparison to literature reported mesoporous carbons.

FIG. 40 is a table of textual properties of SU-MC1, SU-MAC1, and two commercial porous carbon samples.

### DETAILED DESCRIPTION

This section has three parts. In the first section, detailed captions are provided for the figures. The second section relates to experimental work on fabricating porous graphitic carbon from a conjugated polymeric molecular framework. The third section relates to experimental work on fabricating porous carbon from a rationally designed polypyrrole.

### A) Detailed Figure Captions

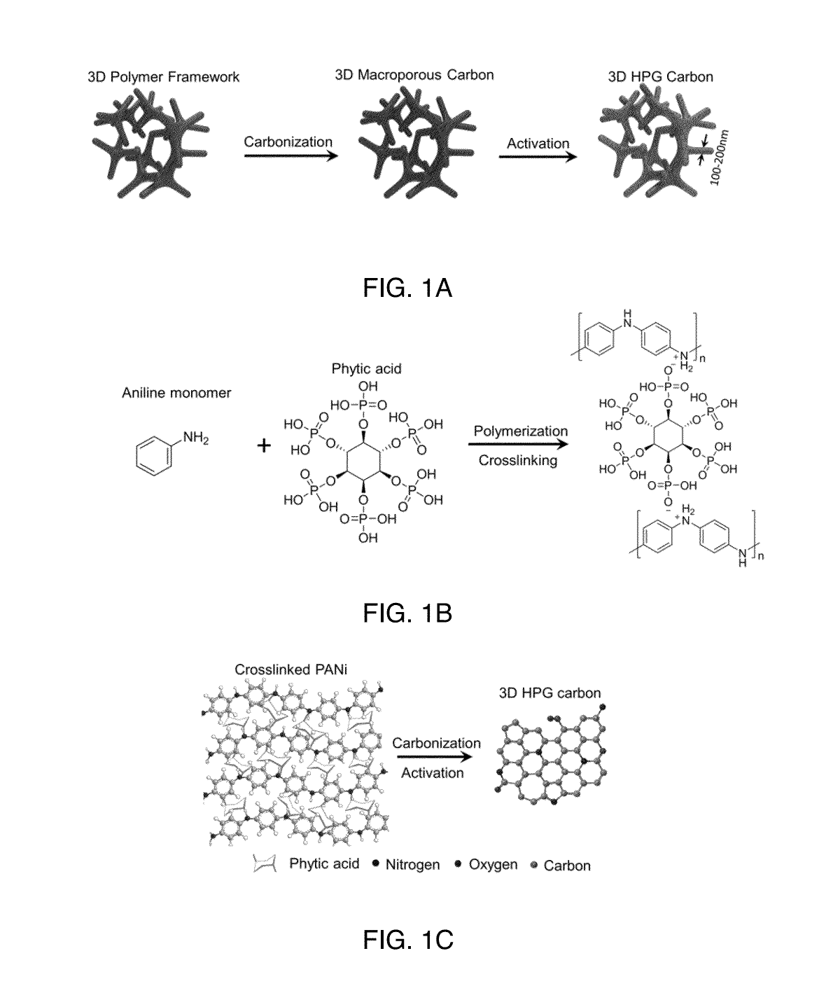

FIGS. 1A-C show synthesis of 3D HPG. FIG. 1A shows schematic synthetic preparation of 3D HPG carbon network from the nanostructure polymer molecular framework. The phytic acid helps to maintain the 3D structure, prevent pore collapse and retain volatile low molecular weight species during carbonization and activation processes. FIG. 1B is an illustration of the chemical synthesis of PANi hydrogel in which the phytic acid acts as both dopant and crosslinker. FIG. 1C is an illustration of transformation of phytic acid-crosslinked PANi (left) into doped graphene-like carbon sheets (right). A total yield of 30 wt % from polymer to 3D HPG carbon is usually obtained.

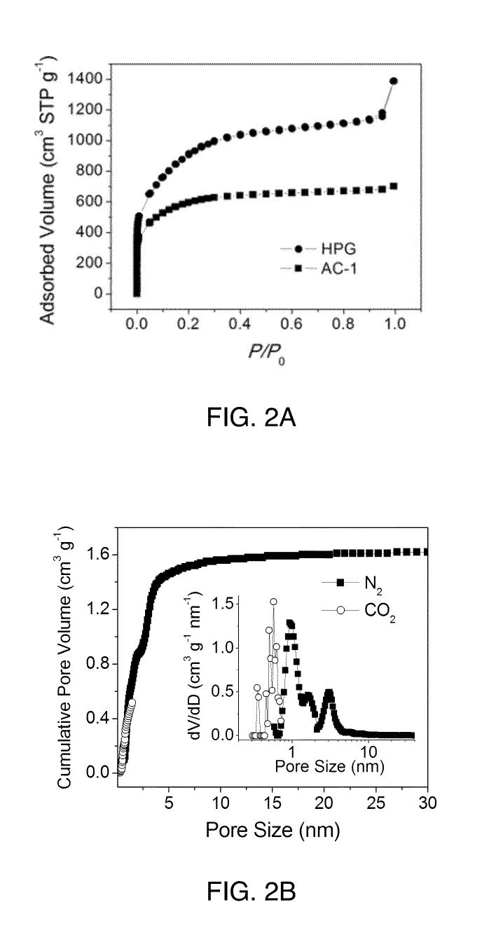

FIGS. 2A-B show porosity and composition of 3D HPG carbon. FIG. 2A shows the N₂ adsorption/desorption isotherm of HPG carbon, clearly showing effects of the hierarchically porous structure. The significant N₂ uptake at a relative pressure (P/P₀) below 0.01 is the characteristic behavior of micropores. The continuous N₂ uptake at P/P₀ between 0.05 and 0.3 is attributed to N₂ adsorption in the mesopores. The N₂ uptake with a relatively flat region followed by a rapid increase at P/P₀ of 0.9 suggests the existence of large mesopores and macropores. Isotherms of a commercial high surface area AC (AC-1, for supercapacitor application with high S_{BET} of 1970 m² g⁻¹) are also provided for comparison. No obvious continuous N₂ uptake at P/P₀ between 0.05 and 0.3 indicates the lack of sufficient mesopores. FIG. 2B shows cumulative pore volume and pore size distribution (inset) for N₂ and CO₂ adsorption. Pore size distribution was calculated by nonlinear density functional theory (NLDFT) by assuming slit pore geometry for micropores and cylindrical geometry pore for mesopores.

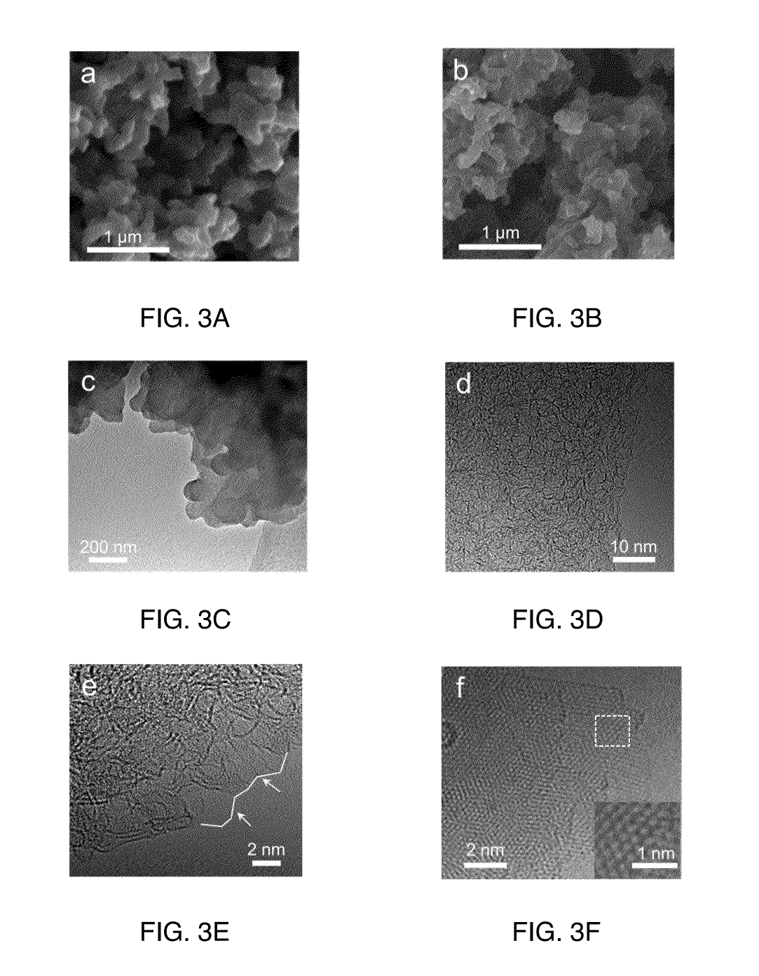

FIGS. 3A-F show structure and morphology of 3D HPG carbon. FIG. 3A is an SEM image of carbonized PAni polymer at 700° C. FIGS. 3B and 3C are SEM and TEM images (respectively) showing the macroscopic network (primary) and macroporous feature of the 3D HPG carbon after activation at 800° C. FIG. 3D is a TEM image revealing the mesoporous structure of the graphitic network (secondary) after 800° C. activation. FIG. 3E is an HR-TEM image showing the network of graphene sheets, which usually have a lateral dimension of a few nm. FIG. 3F is an HRTEM image showing a relatively large graphene sheet with clearly ordered hexagonal carbon atom packing. The inset shows the zoomed-in image at the box in FIG. 3F.

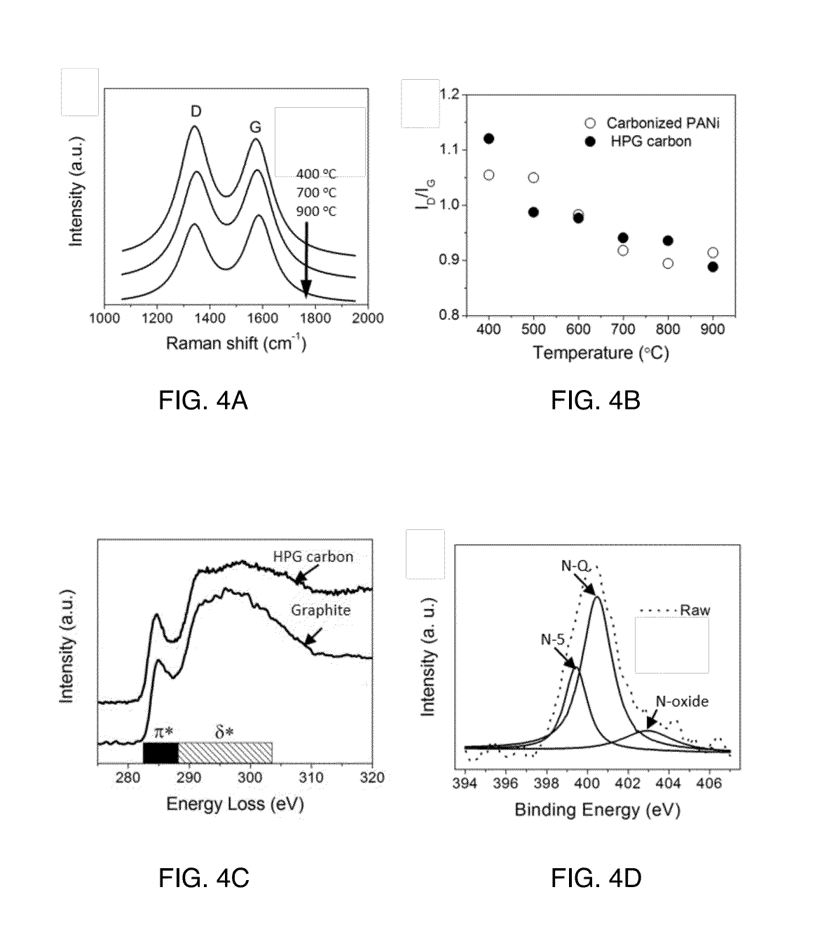

FIG. 4A shows Raman spectrums of 3D HPG carbons made from activation of carbonized PANi aerogel at 400, 700 and 900° C. FIG. 4B is a summary of I_{D}/I_{G} for carbonized PANi and 3D HPG carbons from different carbonization temperatures. FIG. 4C is a comparison of EELS spectra of HPG carbon and graphite suggesting a large portion (˜94%±5%) of sp² bonding in the HPG carbon. FIG. 4D is an N1s XPS spectra indicating the existence of N dopants at different chemical environment in the carbon framework.

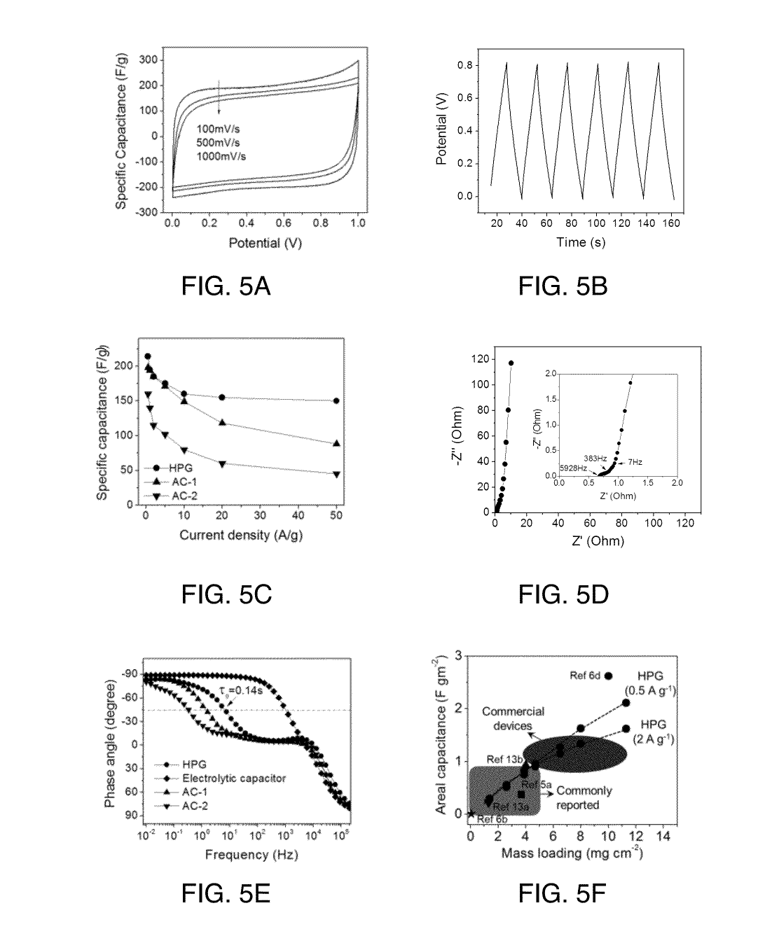

FIGS. 5A-F show HPG carbon supercapacitor performance in 0.5 M H₂SO₄ aqueous electrolyte. FIG. 5A shows representative CV curves of HPG carbon supercapacitors at scan rates of 100, 500 and 1000 mV s⁻¹. The mass loading of electrodes for CV measurement was ˜1.5 mg cm⁻². FIG. 5B shows a representative galvanostatic charge/discharge curve of single HPG carbon electrode (in three-electrode cell) at a current density of 10 A g⁻¹. FIG. 5C shows specific capacitance dependence on current density of supercapacitor electrodes made from different porous carbon. The HPG carbon show higher capacitance and significantly better rate capability than ACs. FIG. 5D is a Nyquist plot of a symmetric supercapacitor device made from HPG carbon. Inset shows the high frequency range. FIG. 5E shows impedance phase angle versus frequency for a HPG carbon- and two commercial AC-based supercapacitors. A commercial electrolytic capacitor was also compared. The characteristic frequency f₀ occurs at phase angle of 45° where resistive and capacitive impedance are equal. As expected, the electrolytic capacitor shows a high characteristic frequency f₀ of 1,000 Hz due to the absence of ion diffusion process. The f₀ occurs at ˜7 Hz for HPG carbon, 1 Hz for AC-1 and ˜0.1 Hz for AC-2. (f) Dependence of areal capacitance on mass loading of HPG carbon electrodes at a current densities of 0.5 and 2 A g⁻¹. Commercial supercapacitors have an areal capacity of ˜1 F cm⁻², while most of recently reported high-performance electrodes have low or moderate areal capacity (<1 F cm⁻²)

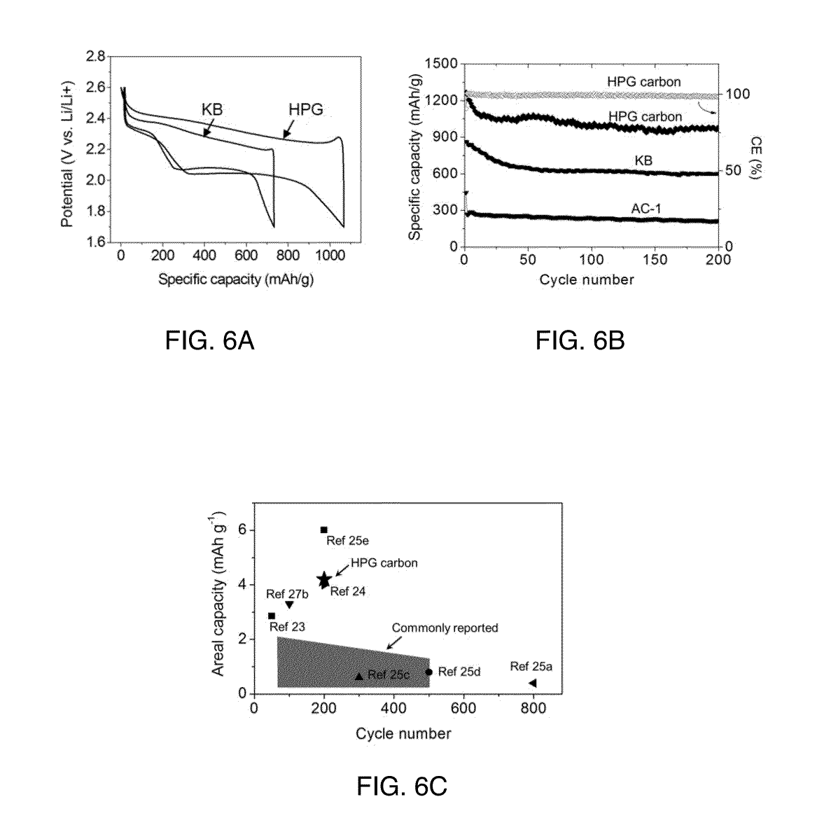

FIGS. 6A-C show electrochemical performance of 3D HPG carbon for Li—S batteries. FIG. 6A shows charge/discharge voltage profiles at a C/5 current rate for HPG carbon/polysulfide and KB/polysulfide electrode after equilibrium, respectively. The discharging curve starts with plateaus at 2.4 and 2.05 V, while the charging curve displayed overlapped plateaus starting from 2.4 V. FIG. 6B shows long-term cycling stability of HPG carbon/polysulfide (3.2 mg cm⁻²), AC-1/polysulfide (2.56 mg cm⁻²) and KB/polysulfide (1.28 mg cm²) electrodes, respectively. After initial activation, high Coulombic Efficiency (CE, ˜99.8%) was maintained for HPG carbon electrode during all the cycles. FIG. 6C shows comparison of areal capacity and cycling life between HPG carbon/sulfur electrodes and recently reported high-performance sulfur electrodes. Previously reported sulfur electrodes often had areal capacity of below 3 mAh g⁻¹ and cycling lifetime of less than 200 cycles.

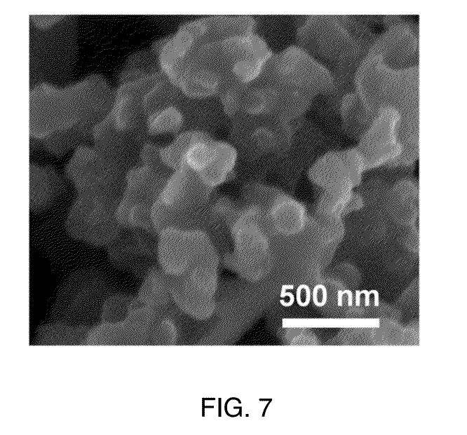

FIG. 7 is an SEM image of dry PANi polymeric framework. The macroporous and network structure is created by the rapid polymerization process.

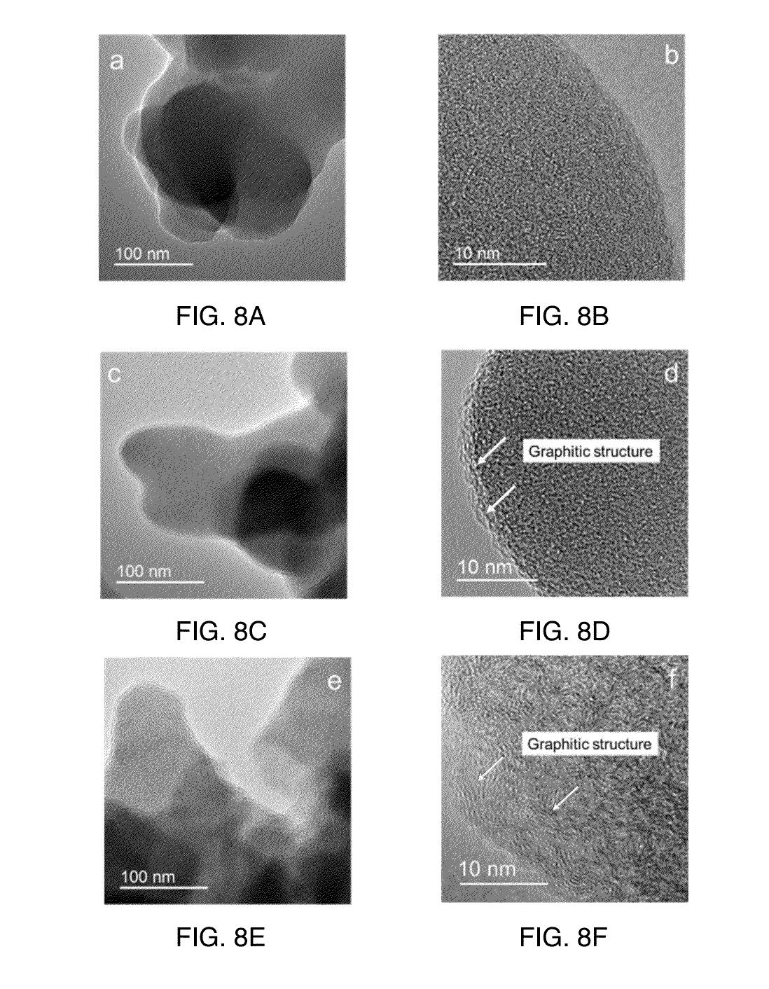

FIGS. 8A-F are TEM images of carbonized PANi polymers at different temperatures, 400° C. (FIGS. 8A-B), 700° C. (FIGS. 8C-D) and 900° C. (FIGS. 8E-F) for 2 h under nitrogen atmosphere. The “embryonic” graphene layers in the carbonized polymer increase as carbonization temperature increases.

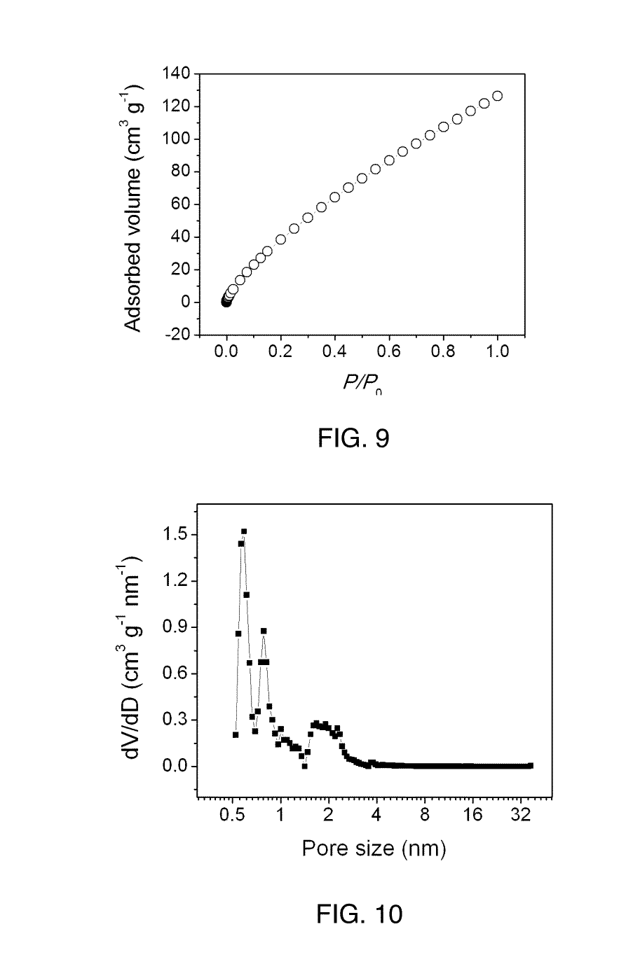

FIG. 9 shows the CO₂ adsorption/desorption isotherm of 3D HPG carbon (carbonized at 700° C.) at 273K.

FIG. 10 shows pore size distribution of AC-1 from N₂ adsorption/desorption.

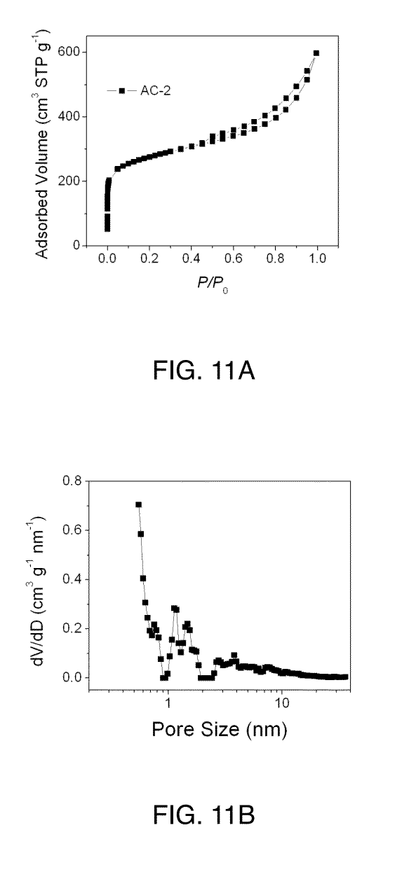

FIG. 11A shows N₂ adsorption/desorption isotherms (77 K) of AC-2 (activated carbon from Sigma-Aldrich). FIG. 11B shows pore size distribution of AC-2 (activated carbon from Sigma-Aldrich), showing limited mesopores and macropores.

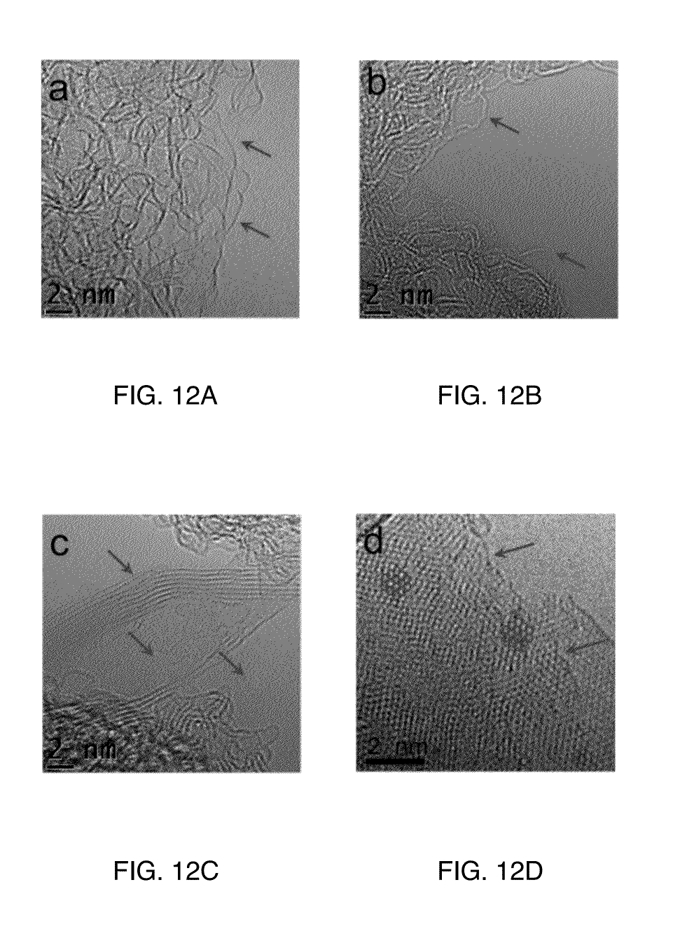

FIGS. 12A-D are extra HRTEM images showing the graphene nano-sheets in the 3D HPG carbons (carbonized at 700° C.). Arrows indicate clear hexagonal carbon atom packing

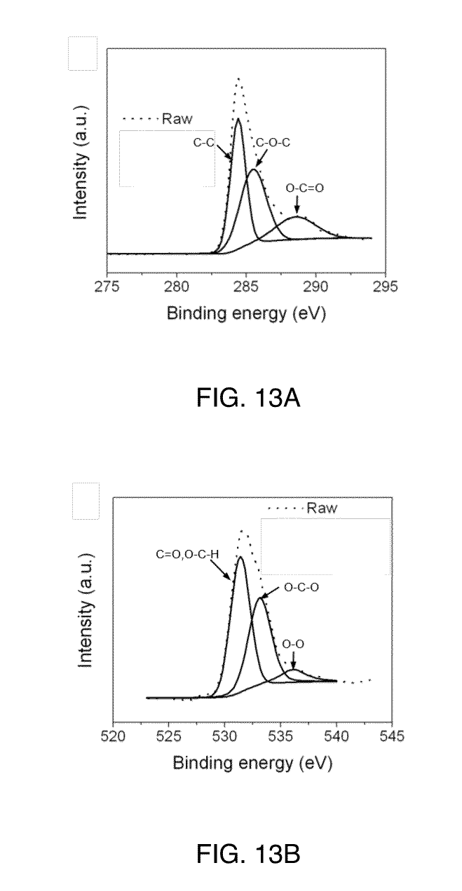

FIGS. 13A-B show XPS results. More specifically, FIG. 13A shows the C1s XPS spectrum and FIG. 13B shows the O1s XPS spectrum of the HPG carbon (carbonized at 700° C.).

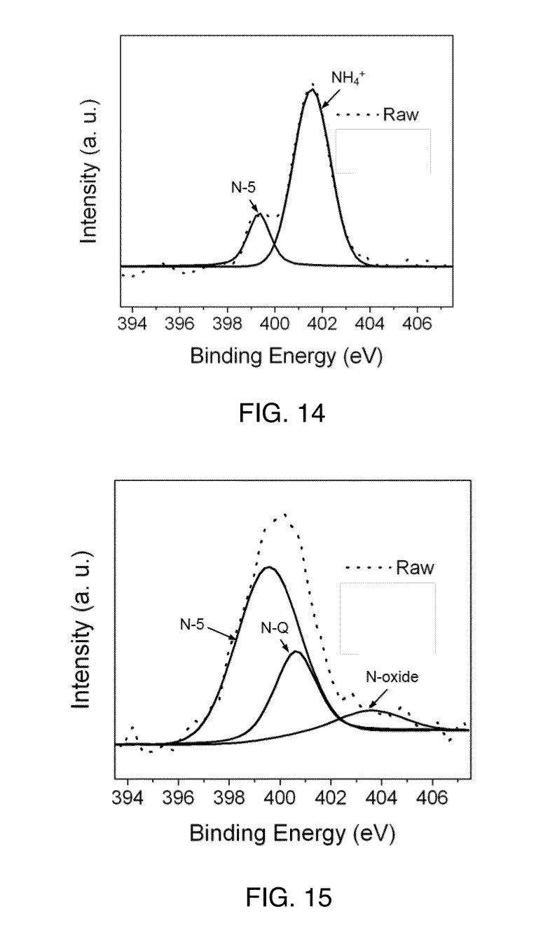

FIG. 14 shows the XPS N1s spectra of PANi polymer framework. Most of N signal originates from NH⁴⁺ (from oxidizing agent), and there is no signal from N-O.

FIG. 15 shows the XPS N1s spectra of carbonized PANi polymer at 700° C. Most of N signal originates from N-5 from aniline monomer, and N-Q and N-O come from the carbonization/pyrolysis process under high temperature.

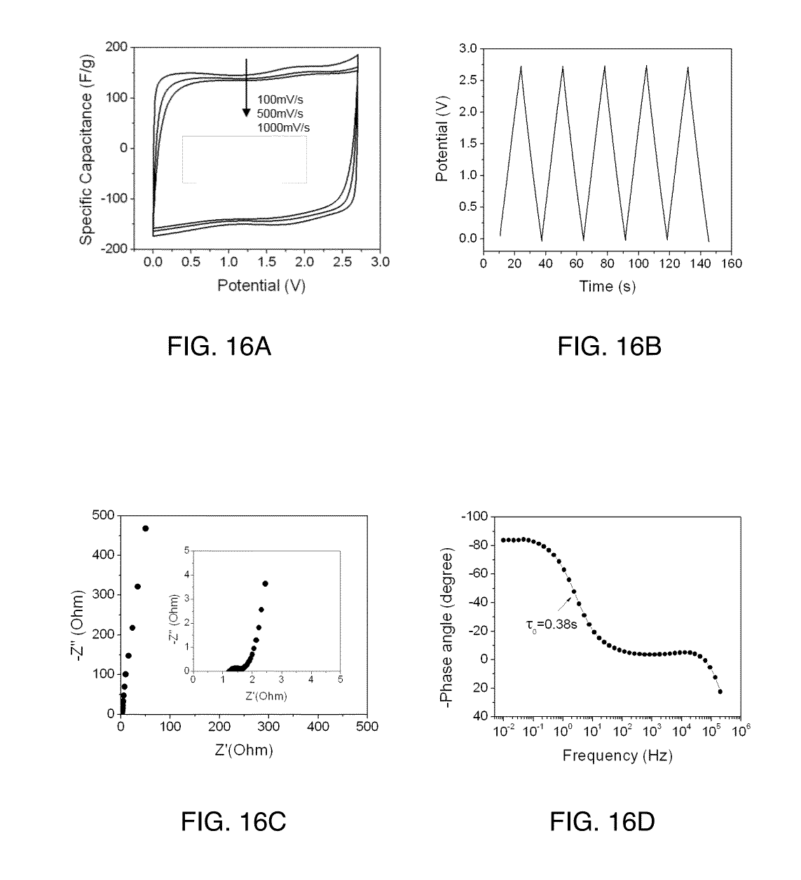

FIGS. 16A-D show HPG carbon-based supercapacitor performance in organic 1 M TEABF₄/ACN electrolyte. FIG. 16A shows representative CV curves of HPG-carbon supercapacitors at scan rates of 100, 500 and 1000 mV s⁻¹. Nearly perfect rectangular CV curves can be obtained at a potential sweep rate as high as 1000 mV s⁻¹, indicating fast electrode kinetics. FIG. 16B shows a representative galvanostatic charge/discharge curve of single HPG carbon electrode (in three-electrode cell) at a current density of 10 A g⁻¹. The linear GC plots show pure capacitive charge/discharge with small IR drop (0.036V). FIG. 16C is a Nyquist plot of a symmetric supercapacitor device made from HPG carbon. Inset shows the high frequency range. FIG. 16D shows impedance phase angle versus frequency for a HPG carbon supercapacitor. The −45° phase angle occurs at ˜2.6 Hz, indicating a fast ion response.

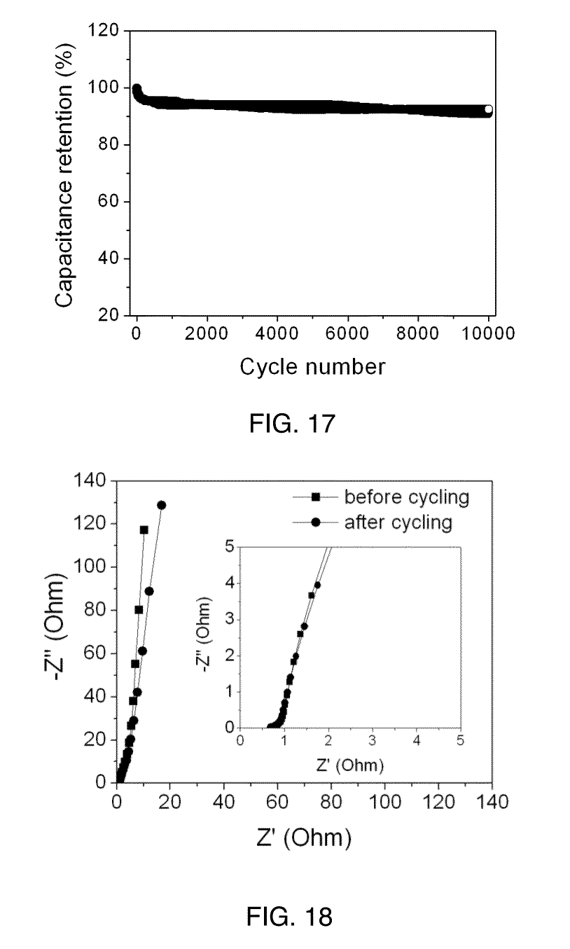

FIG. 17 shows long-term cycling stability of symmetric HPG carbon-based supercapacitors in 0.5 M H₂SO₄ electrolyte. The charge/discharge current rate was 5 A g⁻¹.

FIG. 18 is a Nyquist plot of a HPG carbon-based symmetric supercapacitor cycled before and after 10000 cycles in 0.5 M H₂SO₄. Inset shows the high frequency range. The cell ESR shows almost no change after long-term cycling.

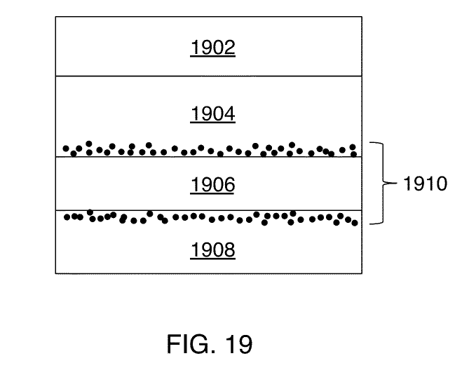

FIG. 19 is a schematic showing the structure of the Li-polysulfide cell using 3D HPG carbon as the sulfur host. In this example, 1902 is lithium, 1904 is the separator, 1906 is the polysulfide, 1908 is the aluminum current collector, and 1910 refers to the subassembly where HPG provides the sulfur host. The HPG carbon (black dots on drawing) was uniformly coated on both current collector and separator, and polysulfide active material was added onto current collector.

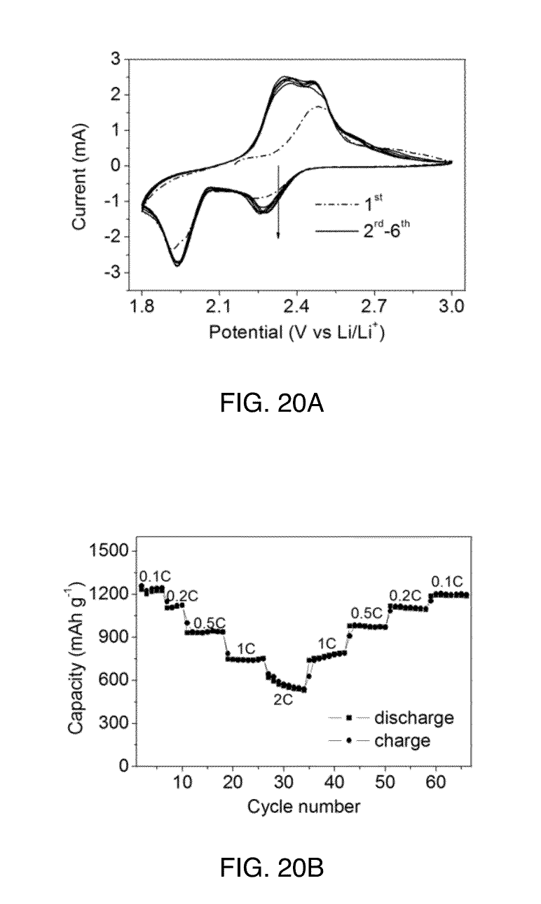

FIGS. 20A-B show electrochemical performance of 3D HPG carbon in Li—S batteries. FIG. 20A shows CV curves (initial 6 cycles) of HPG carbon/polysulfide at a scan rate of 0.5 mV s⁻¹. Measured CV plots of the HPG carbon/polysulfide electrodes in initial cycles show a standard two-step reduction/oxidation process. No significant changes of peak intensity and potential shift can be observed during repeated cycling, which suggests the highly reversible redox reactions and good cycling stability. The two cathodic peaks at 2.3 and 1.9 V correspond to the reduction of elemental sulfur (S₈) into long-chain polysulfide (Li₂Sₙ, 4≦n≦8) and long-chain polysulfide to short-chain polysulfide (Li₂S₂ and Li₂S, respectively). The two oxidation peaks overlapping at 2.4 V involve the conversion of short-chain polysulfide to long-chain polysulfide (Li₂Sₙ, n≧2). FIG. 20B shows rate capability of HPG carbon/polysulfide electrode at a sulfur mass loading of 3.2 mg cm⁻². After cycling at higher rate, the initial low rate capacity can be almost recovered by returning to a lower rate

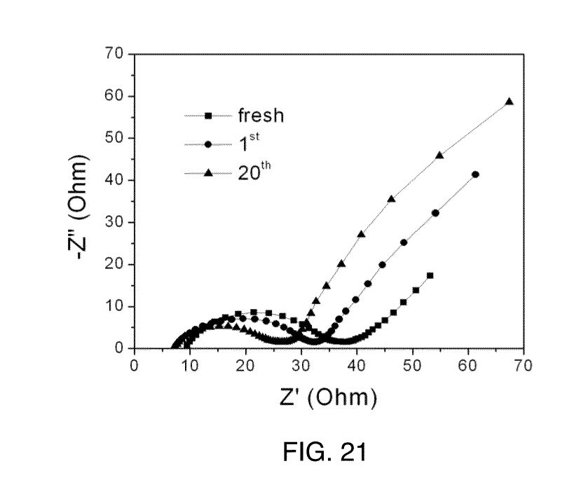

FIG. 21 shows Nyquist plots of a HPG carbon-based Li—S battery at different cycling status. The cell ESR decreased slightly after activation and initial cycling, which maintained a stable cycling performance of the cell. This behavior may be due to the effective trapping and homogenous distribution of lithium sulfide in the ultra-high surface area porous conductive network during repeated charging/discharging. The sulfur mass loading of this cell is 3.2 mg cm⁻².

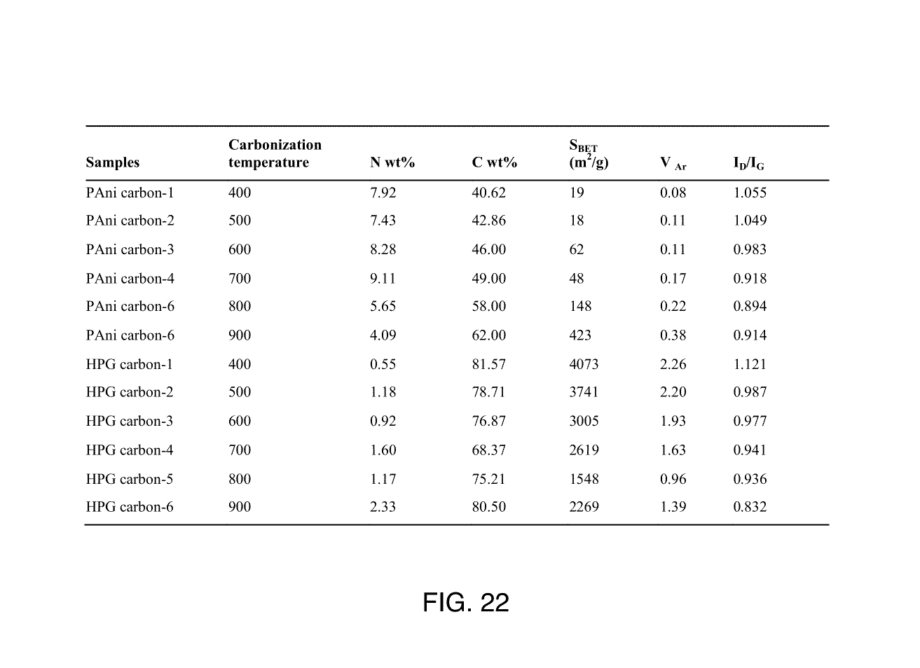

FIG. 22 is a table that gives a summary of different porous carbons synthesized at various conditions. All surface area measurements were conducted with Argon to access narrow micropores at 87 K using BET method. The pore volumes are determined based on non-local density functional theory (NLDFT) calculation.

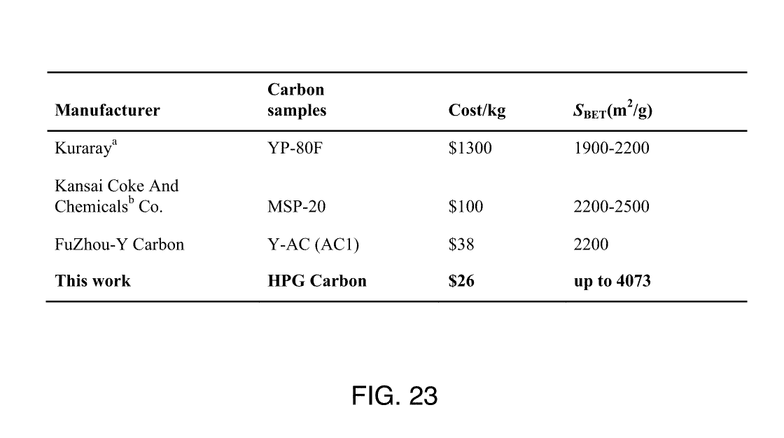

FIG. 23 is a table showing the price of various types of activated carbon.

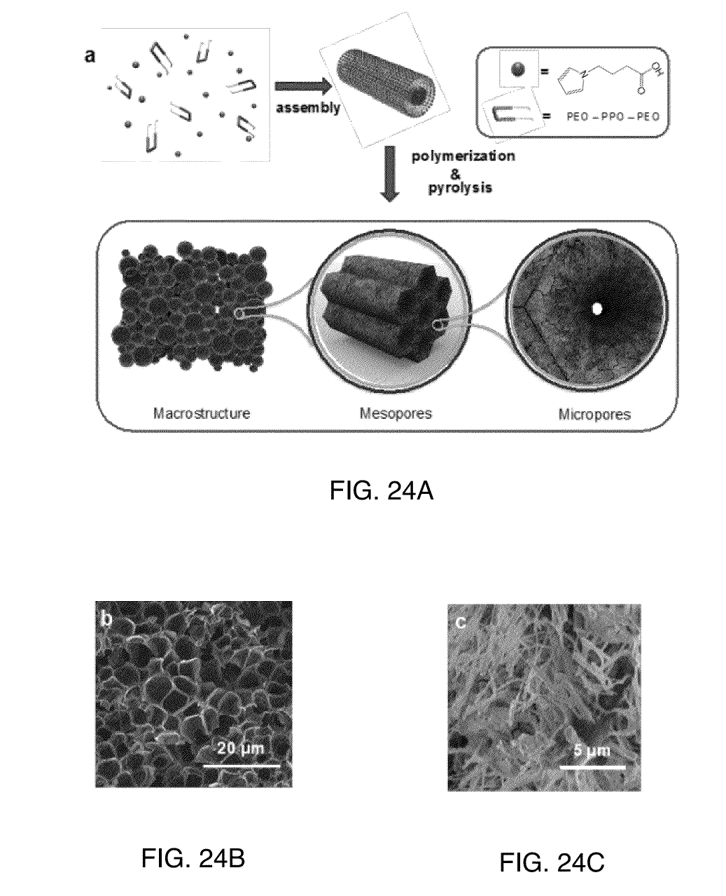

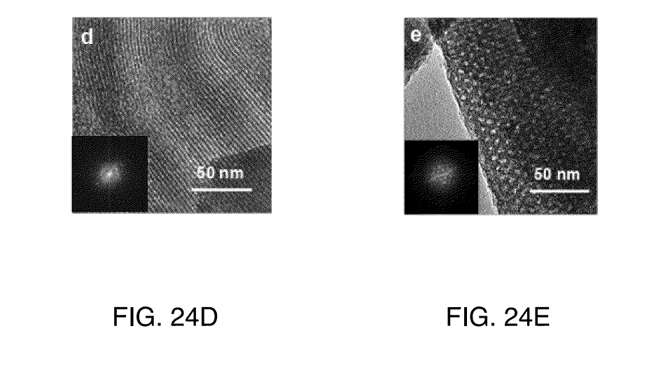

FIGS. 24A-E show a synthesis scheme and characterization of N-doped Mesoporous carbon. FIG. 24A is a schematic showing the synthesis and the hierarchical porous structures of the SU-MC1 material. FIGS. 24B and 24C are scanning electron microscopic (SEM) images of SU-MC1 synthesized at pH=1 and pH=3.5, respectively. FIGS. 24D-E are transmission electronic microscopy (TEM) images of SU-MC1 showing the [110] and the directions of the hexagonal array, respectively (insets: fast Fourier diffractograms).

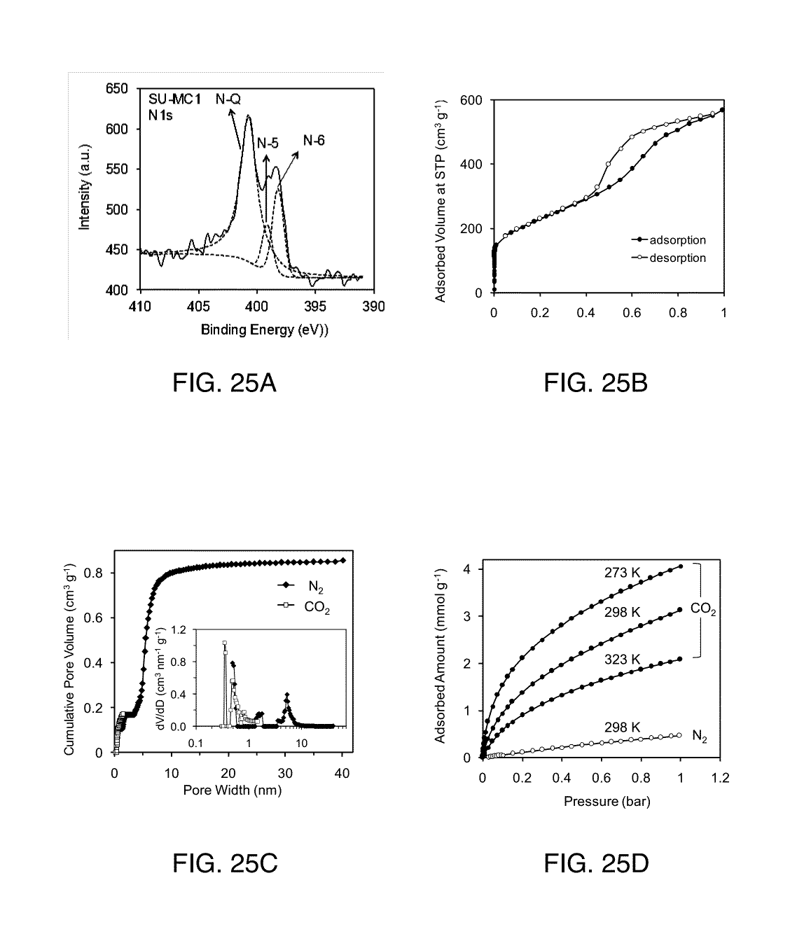

FIGS. 25A-D show characterization and gas sorption behaviors of SU-MC1. FIG. 25A shows X-ray photoelectron spectroscopy (XPS) on N1s (398.4 eV: N-6, 399.8 eV: N-5, 400.8 eV: N-Q). FIG. 25B shows nitrogen adsorption and desorption isotherms at 77 K. FIG. 25C shows cumulative pore volumes and pore size distributions (inset) from non-local density functional theory (NLDFT) calculations based upon the nitrogen isotherm at 77 K (solid symbols) and CO₂ isotherm at 273 K (open symbols). FIG. 25D shows CO₂ isotherms at 273, 298 and 323 K and N₂ isotherm at 298 K.

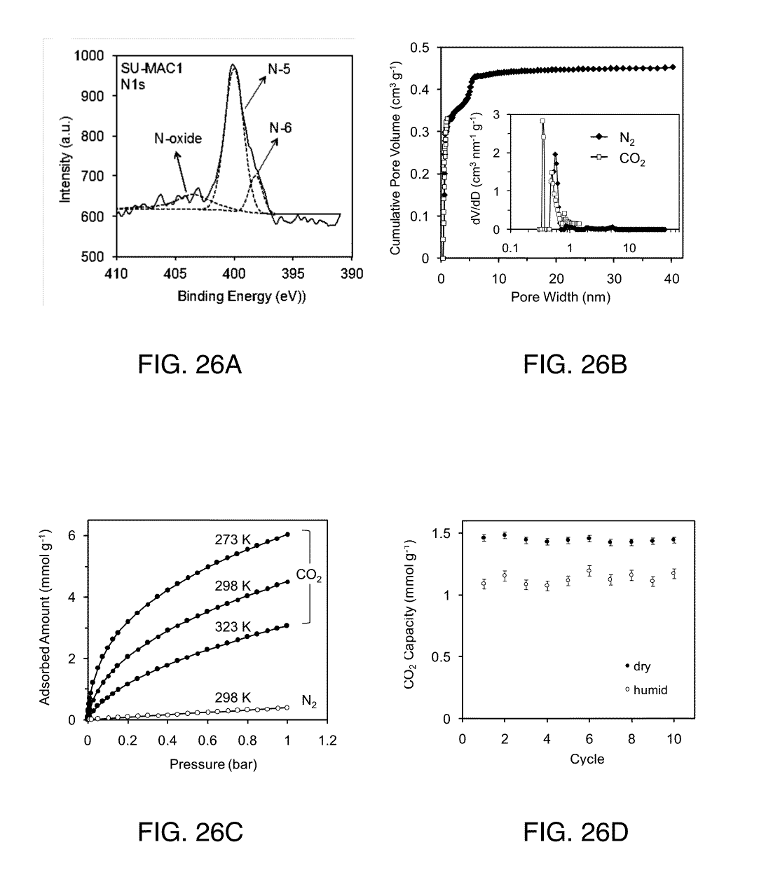

FIGS. 26A-D show characterization and gas sorption behaviors of SU-MAC1. FIG. 26A shows X-ray photoelectron spectroscopy (XPS) on N1s (398.1 eV: N-6, 400.0 eV: N-5, 403.4 eV: N-oxide). FIG. 26B shows cumulative pore volumes and pore size distributions (inset) from non-local density functional theory (NLDFT) calculations based upon the nitrogen isotherm at 77 K (solid symbols) and CO₂ isotherm at 273 K (open symbols). FIG. 26C shows CO₂ isotherms at 273, 298 and 323 K and N₂ isotherm at 298 K. FIG. 26D shows multi-cycle dynamic column adsorption capacity (298 K) of CO₂ at a CO₂ partial pressure of 0.1 bar with balance N₂ under dry and humid conditions.

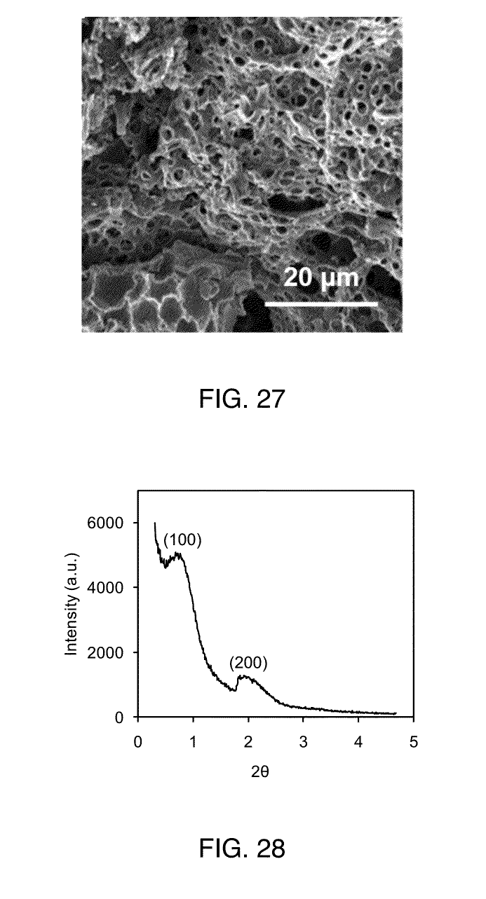

FIG. 27 shows scanning electron microscopy (SEM) of the SU-MC1 material synthesized at pH=1.

FIG. 28 shows small-angle X-ray diffraction (XRD) pattern of SU-MC1.

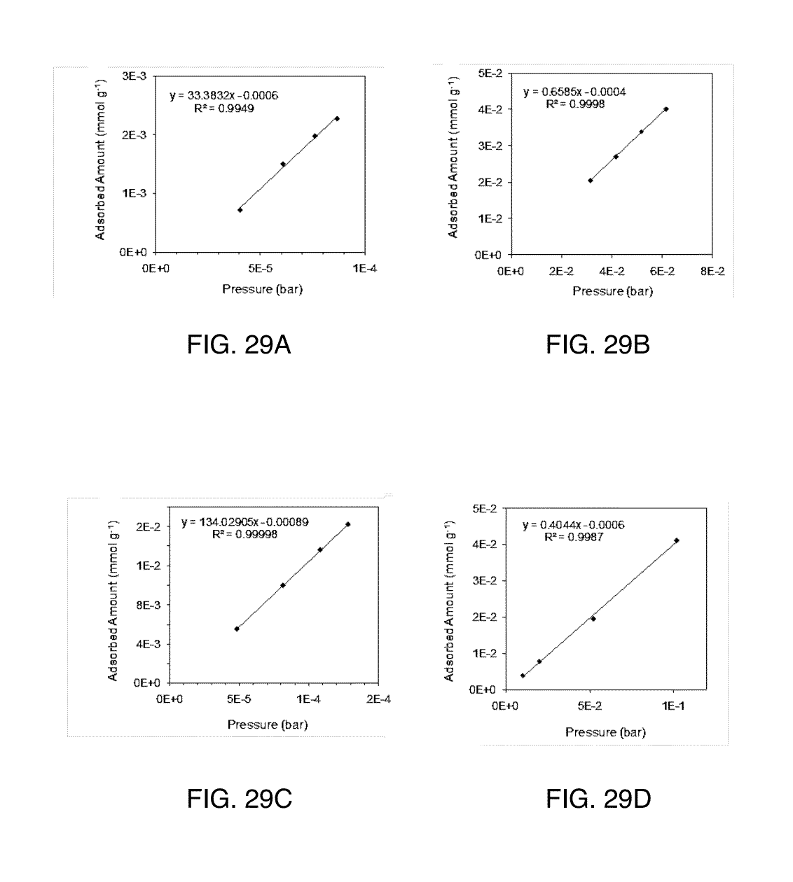

FIGS. 29A-D show initial slopes of CO₂ and N₂ isotherms at 298 K for two samples. FIG. 29A relates to SU-MC1, CO₂. FIG. 29B relates to SU-MC1, N₂. FIG. 29C relates to SU-MAC1, CO₂. FIG. 29D relates to SU-MAC1, N₂.

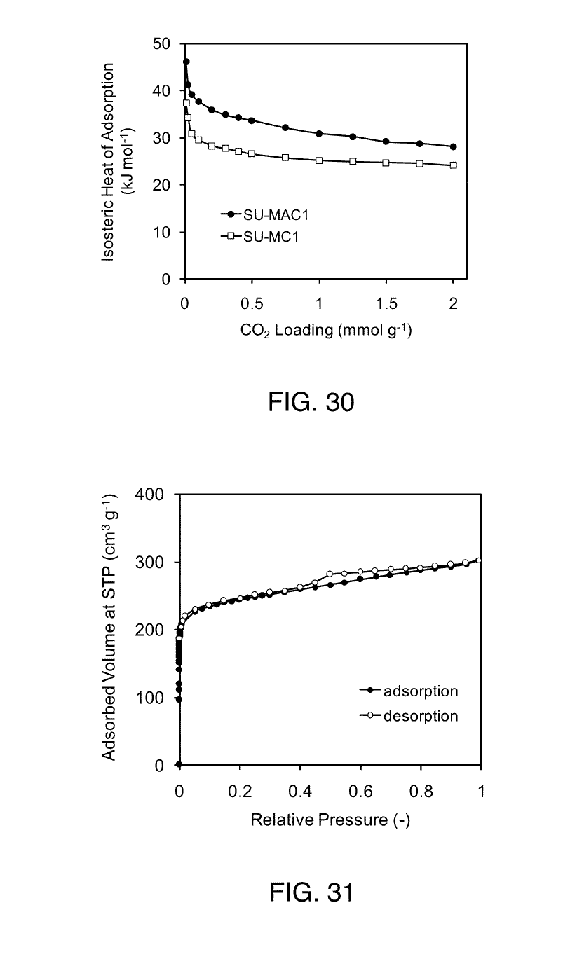

FIG. 30 shows isosteric heat of CO₂ adsorption onto SU-MC1 and SU-MAC1, calculated using the Clausius-Clapeyron equation based upon the CO₂ isotherms at 273, 298 and 323 K.

FIG. 31 shows N₂ adsorption and desorption isotherms of SU-MAC1 at 77 K.

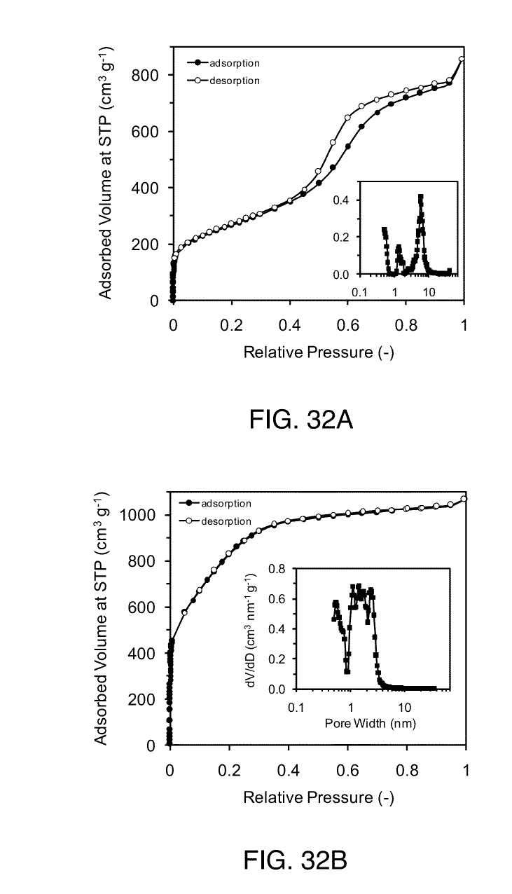

FIGS. 32A-B show N₂ adsorption and desorption isotherm at 77 K for two samples. FIG. 32A relates to CMK-3 (ordered mesoporous carbon showing type IV isotherm with a characteristic mesopore hysteretic loop) and FIG. 32B relates to Maxsorb (high-surface area activated carbon showing type I isotherm with microporous features) with insets as the pore size distributions by NLDFT based upon the N₂ isotherms. The x and y axes of the inset in FIG. 32A are pore width (nm) and dV/dD (cm³ nm⁻¹ g⁻¹), respectively.

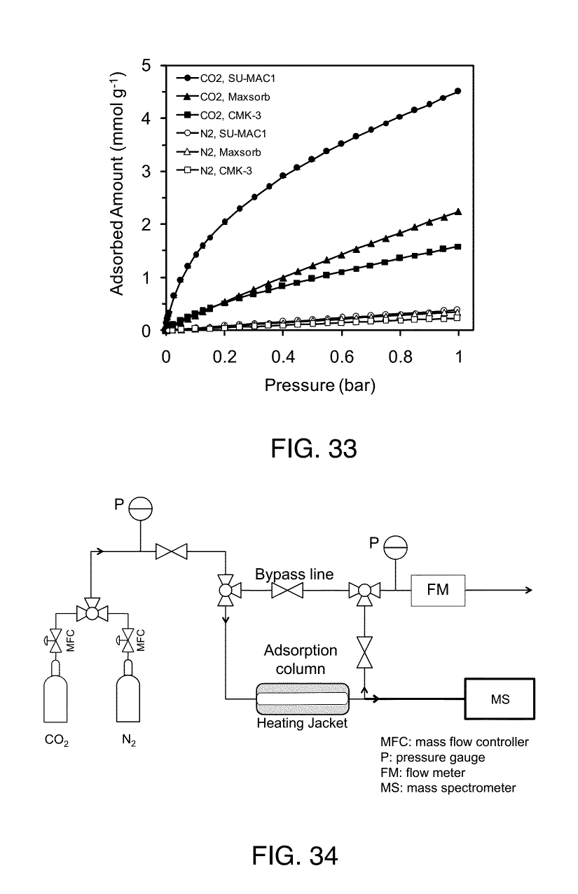

FIG. 33 shows CO₂ and N₂ adsorption isotherms of SU-MAC1 in comparison with Maxsorb and CMK-3 at 298 K.

FIG. 34 shows the experimental setup for dynamic column breakthrough experiments.

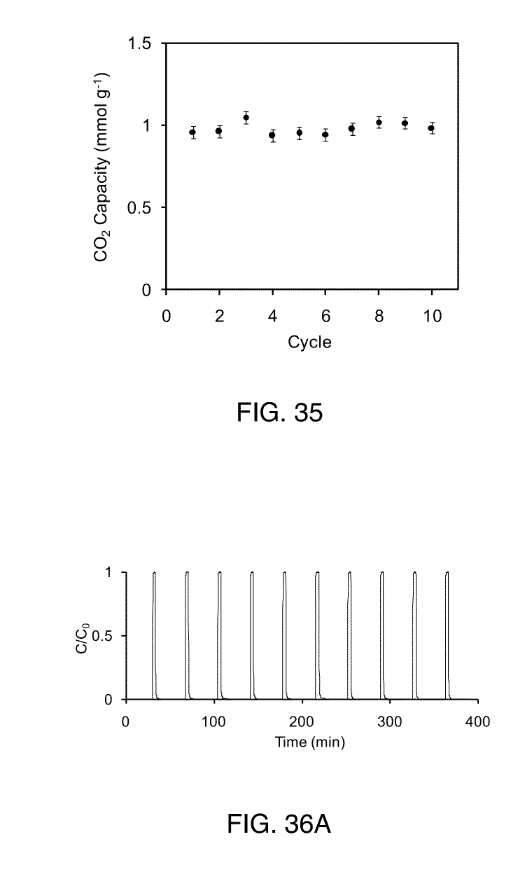

FIG. 35 shows multi-cycle dynamic column adsorption capacity (298 K) of CO₂ by SU-MC1 at a CO₂ partial pressure of 0.1 bar with balance N₂.

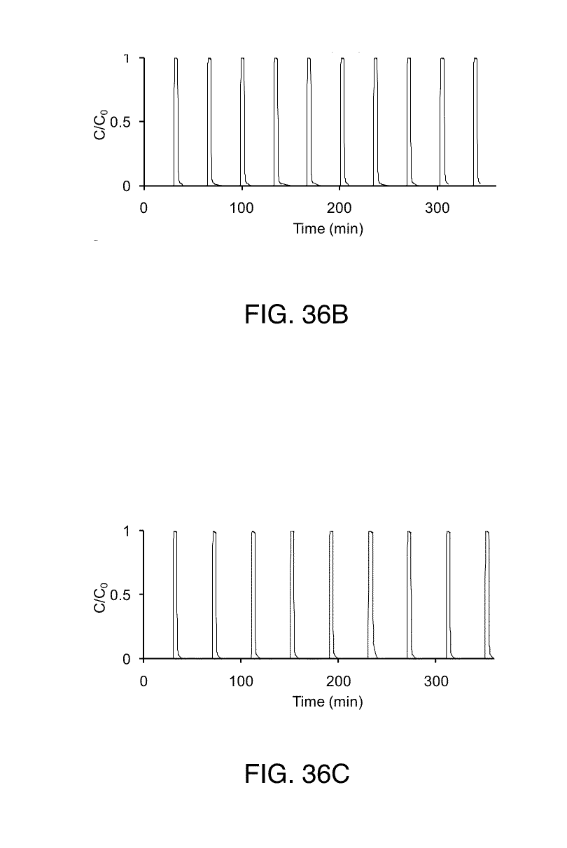

FIG. 36A shows normalized CO₂ composition detected by mass spectrometry in the dynamic column breakthrough experiments on SU-MC1 under dry conditions. FIGS. 36B-C show corresponding results for SU-MAC1 under dry (FIG. 36B) and humid conditions (FIG. 36C).

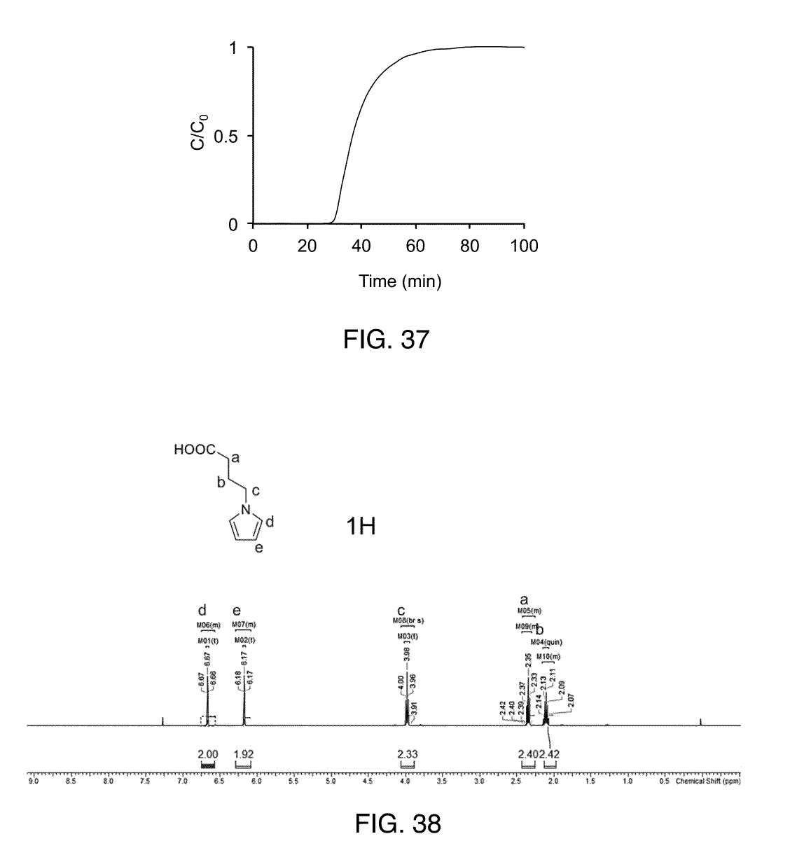

FIG. 37 shows normalized CO₂ composition detected by mass spectrometry for CO₂ breakthrough on SU-MAC1 with acidic impurities.

FIG. 38 is an ¹H NMR spectrum of 4-(Pyrrol-1-yl)butanoic acid.

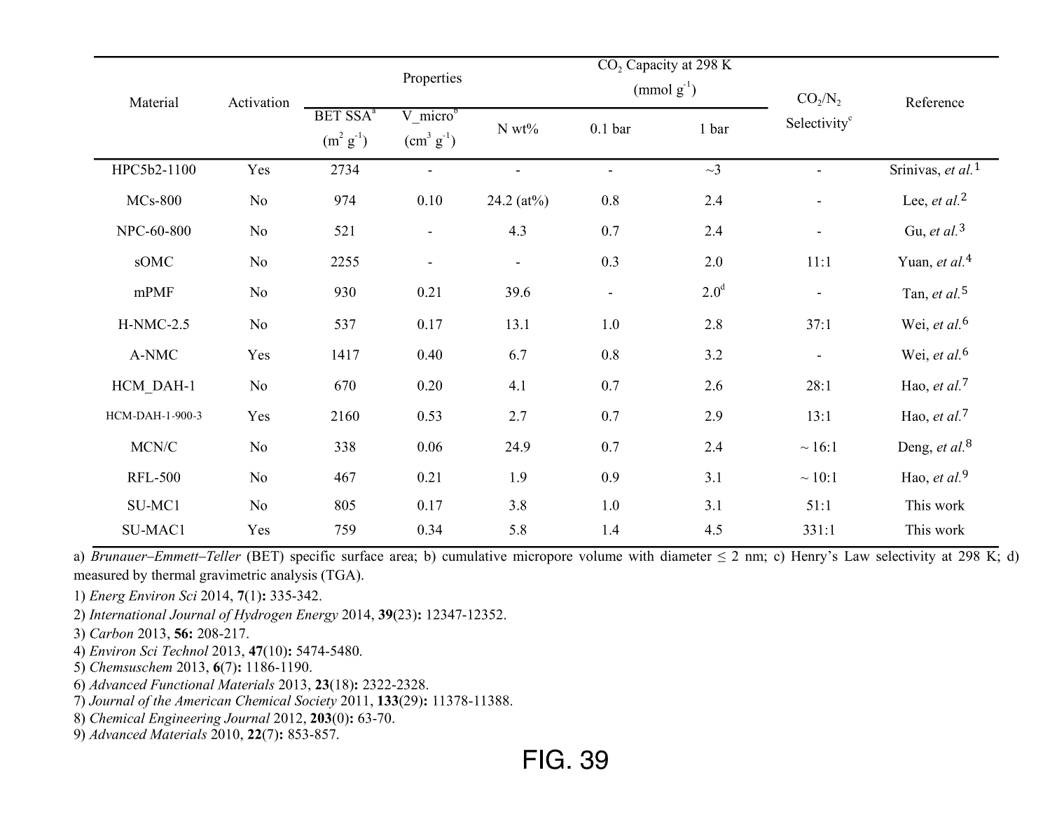

FIG. 39 is a table of textual properties and CO₂ capture performances of SU-MC1 and SU-MAC1 in comparison to literature reported mesoporous carbons.

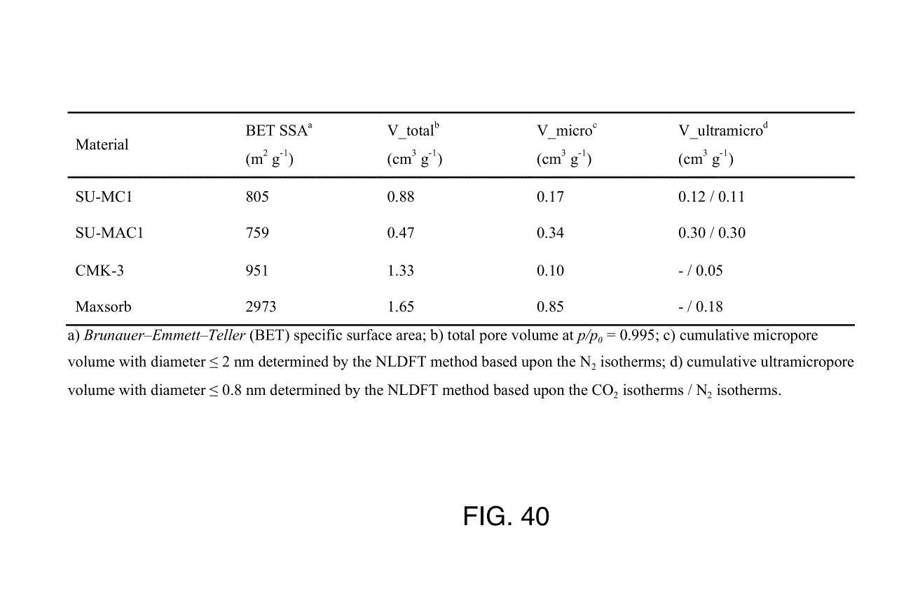

FIG. 40 is a table of textual properties of SU-MC1, SU-MAC1, CMK-3 and Maxsorb.

B) Porous Graphitic Carbon from a Conjugated Polymeric Molecular Framework

### B1) Introduction

High surface area porous carbon materials are of great technological importance due to their diverse functionalities and excellent physical/chemical robustness. Their high electronic conductivity, large surface area and good chemical and electrochemical stability are of particular interest for electrochemical energy storage devices, such as electrochemical capacitor (or supercapacitors) and batteries. Fundamentally, the performance of such devices mainly depends on the capability of carbon materials to interact with ions and to transport electrons. For example, an ideal supercapacitor carbon material requires high conductivity for electron transport, high surface area for effective ion adsorption/desorption and suitable pore architecture for rapid access of ions from electrolyte solution to the carbon surface. Traditional porous carbon materials, such as activated carbons (ACs) have high surface area (up to 3000 m²/g), but their large pore tortuosity and poor pore connectivity severely limit electrolyte ion transport to the surface. Furthermore, they are generally synthesized from coal or biomass (e.g. coconut shell, rice husk) containing a large amount of impurities. As a result, extensive purification is needed to achieve high quality supercapacitor-grade AC, which substantially increases the cost. Soft or hard templates can be used to prepare mesoporous carbons to achieve better pore size control and tunable pore connection; however, complicated and costly synthesis is required, prohibiting their practical applications.

Porous graphitic carbons, such as three-dimensional (3D) porous graphene network, are attracting increasing interests owing to their high intrinsic electronic conductivity and large surface area. However, bulk graphene powder made from random stacking of individual sheets often suffers from severe aggregation, which dramatically decreases its surface area, pore connectivity and electronic conductivity, leading to moderate charge storage performance. While some specially designed 3D porous graphene networks show good pore connectivity and conductivity, large-scale and low-cost fabrication of such graphene networks remains a challenge. The general strategy towards the above-mentioned graphene networks is to use graphene oxides (GOs) as building blocks. However, making conductive graphene from GO building blocks (normally by Hummer's method) requires strong oxidative and subsequently reductive chemicals, which is unfavourable for large-scale production. In this context, efficient synthesis of 3D interconnected graphitic carbon networks remains highly desired.

Herein, we describe a scalable synthesis towards low-cost and low-temperature synthesis of 3D porous graphitic carbon networks with ultra-high surface area and hierarchically interconnected pore architecture. Our strategy is using a 3D crosslinked precursor from a conjugated polymeric molecular framework without using any sacrificial templates (FIG. 1A). As shown in FIGS. 1B-C, we began with the synthesis of a crosslinked conjugated polymeric molecular framework, which can be readily converted into porous carbon simply by thermal annealing (carbonization). A subsequent chemical activation process at a temperature as low as 800° C. further increases the surface area and porosity, leading to a 3D hierarchically porous graphitic (HPG) carbon framework with high surface area (up to 4073 m² g⁻¹), large pore volume (up to 2.26 cm³ g⁻¹) and, high electronic conductivity (>3 times higher than conventional ACs) and good pore connectivity. The resulting HPG carbon materials showed unprecedented energy storage capacity and rate capability compared with previously reported porous carbons, enabling high mass-loading supercapacitors and highly stable lithium-sulfur batteries.

### B2) Results

### B2a) Synthesis of Ultra-High Surface Area and Highly Graphitic Framework at Low Temperature

Our polymer network is termed as “molecular framework” because of its rigid and crosslinked structure. The rigid conjugated polymer backbone, PANi, was formed in the presence of a crosslinker. The hydrogel network is readily formed upon mixing the monomer, oxidizing agent and a crosslinker (see experiments). After water removal by freeze-drying, the hydrogel was converted into an aerogel which maintained the original macroscopic structure of the polymer network. Seen from the scanning electron microscopic (SEM) image (FIG. 7), the dried polymer shows interconnected coral-like nanofibers with diameters of about 100˜200 nm.

Phytic acid is selected as the crosslinker for two reasons: 1) It contains six phosphoric acid groups, which electrostatically associate with protonated aniline to crosslink the entire network, giving rise to the 3D macroscopic structure of a molecular framework. Unlike soft templates which are selected for their low decomposition temperature <300° C., the degradation temperature of phytic acid is relatively high, ˜380° C., which prevents pore collapsing during carbonization. 2) As phytic acid is carbonized, the in-situ formed organophosphates were reported to generate a polymeric layer through the formation of phosphate linkages that connect and further crosslink polymer fragments. This can help to effectively retain the more volatile lower molecular weight species. Indeed, we obtained a high carbon yield (˜50 wt %), which is more than twice that of carbonization of biomass.

At even higher temperatures (>450° C.), cyclization and condensation reactions lead to increases in aromaticity and size of the polyaromatic units, enabled by the scission of P—O—C bonds. Extensive growth of these aromatic units or “embryonic” graphene layers in the carbonized polymer can be observed in transmission electron microscopic (TEM) images (FIGS. 8A-8F). A subsequent chemical activation process by mixing the above graphitized carbon with potassium hydroxide (KOH) followed by a heat treatment at 800° C. further increases the porosity and surface area. After activation, an overall carbon yield (vs. mass of polymer) of ˜30 wt % can usually be achieved. By comparison, common carbon yield of commercial ACs made from activation of biomass at similar temperature is only ˜8%.

The surface area and pore structure of the polymer-derived porous graphitic carbon can be readily tuned by adjusting the synthetic conditions, such as annealing temperature and activation conditions (FIG. 22). For example, by increasing carbonization temperature from 400 to 900° C., BET (Brunauer-Emmett-Teller) surface area (S_{BET}) can be increased from 20 m² g⁻¹ to 423 m² g⁻¹. At the same time, the pore volume (V_{Ar}, measured with argon) can be increased from 0.04 to 0.38 cm³ g⁻¹. Subsequent chemical activation of these carbons can further enhance S_{BET} to as high as 4073 m² g⁻¹ and V_{Ar} to 2.26 cm³ g⁻¹. This effect may have contributions from the activation from phosphoric acid group and organophosphate moieties that are generated during decomposition of phytic acid. Note that the highest surface area attained is the sample with the lowest carbonization temperature (400° C.), and as the carbonization temperature increases to 900° C. while fixing the activation temperature and KOH/C ratio, S_{BET} first decreases then increases. This confirms the unique role of phytic acid as a crosslinker and its effect in retaining the structural integrity at moderate temperature. Such high S_{BET} together with large V_{Ar} is the highest achieved among graphitic carbons. This value is even higher than the previously reported activated graphene (S_{BET}=3100 m² g⁻¹, V_{Ar}=2.14 cm³ g⁻¹).

Detailed pore structure was probed by N₂ adsorption/desorption techniques at 77 K (FIG. 2A), which clearly showed the coexistence of micro-, meso- and macropores of characteristic of our 3D HPG carbons. CO₂ adsorption/desorption isotherm at 273 K further revealed a steady increase of CO₂ uptake under low pressure (FIG. 9). FIG. 2B summarizes the cumulative pore volume and pore size distribution from N₂ and CO₂ adsorption. By comparison, a conventional commercial high surface area AC (FIG. 2A) only shows micropores with small peak pore size (˜0.6 nm, FIGS. 10 and 11A-B) and moderate V_{Ar} (0.997 cm³ g⁻¹). The existence of abundant meso/macropores in the HPG carbon allows a better mass transport than normal ACs with only micropores. The high flexibility of this synthetic approach makes it possible unprecedented performance for a wide range of applications, such as electrochemical energy storage.

### B2b) Physical and Chemical Characterization of the HPG Carbon

The 3D HPG carbons synthesized at different carbonization temperatures share similar morphology and structure. Detailed microstructure characterization reveals their hierarchical architectures. Representative SEM (FIG. 3A) and TEM images (FIG. 3B) show the interconnected carbon framework (primary) with large pores (a few hundred nm) formed during the polymerization of PANi (FIG. 7). Close examination of the carbon backbone shows a foam-like porous structure with small mesopores with pore sizes in the range of a few nm (FIG. 3C). The observed filamentary carbon structure suggests that carbon sheets further intertwine into a continuous porous framework (secondary). High-resolution TEM (HRTEM) images (FIGS. 3D-E) further identify the interconnected graphene sheets with a few nm lateral dimensions. The ordered hexagonal packing of the carbon atoms in graphene nanosheets can be clearly seen, suggesting a high degree of graphitization of the carbon framework. This porous graphitic structure highly resembles porous graphene derived from chemical activation of graphene oxide at the same temperature, which shows small graphene domains and abundant edge sites. Nevertheless, our HPG carbon shows good pore connectivity originated from the rigid 3D conjugated polymer network, which can prevent particle aggregation or layer-to-layer stacking This HPG carbon structure is in sharp contrast to previously reported pyrolysis porous carbons, which mostly contain amorphous carbon at similar or even higher carbonization temperatures.

Raman spectroscopy further confirms the strong graphitization of all the 3D HPG carbons as featured by intensive G-bands at 1590 cm⁻¹ (FIG. 4A). While graphitic structures were attained for all samples, the degree of graphitization increases with the increase of carbonization temperature. The D-band to G-band intensity ratio (I_{D}/I_{G}) was calculated to be 1.12, 0.94 and 0.88 for HPG carbon from PANi carbonized at 400° C., 700° C. and 900° C., respectively (FIG. 4B, FIG. 22), which is consistent with their different surface area and porosity. Even the maximum I_{D}/I_{G} is smaller than that of GO-derived activated graphene (˜1.2) with a similar activation condition, indicating a higher degree of graphitization. The amount of sp² carbon is further determined by comparing the π* and σ* bonding to a graphite standard with equivalent thickness by using electron energy loss spectroscopy. For example, the fraction of sp² carbon in HPG carbon (from 900° C. carbonization) was found to be as high as 94% (±5%, FIG. 4C), assuming the graphite reference spectra is 100%. We note that this value may be underestimated due to the presence of abundant small graphene sheets (FIGS. 3B-D and 12A-D) in the filamentary network which can project more edge defects to electron-beam, thus reducing the detected content of sp² carbon.

X-ray photoelectron spectroscopy (XPS) shows that the HPG carbon contains C, N and O dopants (FIGS. 13A-B). The N1s core level spectrum (FIG. 4D) suggests the presence of three types of nitrogen: pyrrolic nitrogen (N-5, 399.5 eV), quarternary-N (N-Q, 400.6 eV) and oxides of pyridine-N peak (N-O, 402.9 eV). The N-5 (25 atom % for total N) originated from structure confinement and low molecular weight PANi produced from the rapid polymerization. The N-Q predominates (61 atom %) due to its highest thermal stability. The existence of N-O (14 atom %) can be ascribed to the oxidizing environment of the activation process. Such development of doping in HPG carbon is also elucidated by analyzing the composition of PANi and carbonized PANi (FIGS. 14-15).

### B2c) Electrochemical Performance of HPG Carbon-Based Supercapacitors

The high surface area and 3D pore structure of the HPG carbon are favourable for electrode applications. In addition, the relatively small carbon particle size offers scalability and high flexibility for processing. Essentially, the HPG carbon-based electrodes can be easily fabricated on various substrates. For example, micro-patterned electrodes can be directly spray-coated on polyethylene terephthalate (PET) sheets, flexible polyimide films or silicon wafers from an ink that is a carbon suspension in ethanol. Very thick electrodes (>100 μm) can be readily blade-coated on metallic substrates using carbon slurry in N-Methyl-2-pyrrolidone (e.g., Ti, Al). Since the carbon particles are composed of interconnected coral-like nanofibers, they provide electrodes with good mechanical flexibility. The resulted electrodes also possess high conductivity (˜300 S m⁻¹), which is close to activated graphene (500 S m⁻¹), significantly higher than strutted graphene (1 S m⁻¹) and commercial ACs (10-100 S m⁻¹). Together with large active surface area, such electrodes hold great potential for supercapacitors, batteries, electrocatalysts and other applications.

HPG carbon electrodes and supercapacitors have been fabricated on different substrates. An interdigital supercapacitor was made by spray coating HPG carbon ink on a gold-coated (50 nm) PET film. A flexible supercapacitor with interdigital electrodes was made by spray coating HPG carbon ink on an Al-coated (50 nm) Kapton® polyimide film with 50 nm Al conducting layer. Ten supercapacitors with interdigital electrodes fabricated at the same time on silicon wafer were made using a removable PDMS (polydimethylsiloxane) mask. A 4 cm*5 cm size electrode (thickness of ˜100 μm) was made by blade-coating HPG carbon slurry on a Ti substrate.

To evaluate supercapacitor performance, we used a conventional slurry coating method to fabricate electrodes. The devices showed high performance in both aqueous and organic electrolyte (FIGS. 16A-D). For example, prototype devices based on HPG carbon maintained rectangular cyclic voltammetry (CV) curves even at a very high voltage sweep rate of 1000 mV s⁻¹ in 0.5 M H₂SO₄ (FIG. 5A), a feature only observed for ideal supercapacitors. Measured galvanostatic charge/discharge profiles show linear curves with a small voltage (IR) drop, for example, only 0.014V drop at a current density as high as 10 A g⁻¹ (FIG. 5B). This value is only ⅕ of the AC-1 (a commonly used supercapacitor carbon) and lower than that of the graphene thin film supercapacitor (0.018V). Specific capacitance of the HPG carbon and of commercial ACs at different current densities from 0.5-50 A g⁻¹ are summarized in FIG. 5C. The HPG carbon showed a capacitance of 225 and 162 F g⁻¹ at a current density of 0.5 and 50 A g⁻¹, respectively, corresponding to a capacitance retention of 72%. By comparison, AC-1 maintained only ˜44% of the initial capacitance (198 to 88 F g⁻¹) as current density increased from 0.5 to 50 A g⁻¹. Even for thin-film graphene, macro-/mesoporous graphene and 3D strutted graphene supercapacitors, the capacitance retention was only ˜50% as current density increased by the same magnitude.

The fast electrode kinetics was further confirmed using electrochemical impedance spectroscopy (EIS). The measured Nyquist plot of HPG carbon (FIG. 5D) reveals a very low electrode series resistance (ESR, ˜0.7 Ohm), which is attributed to the highly graphitized porous network. The nearly vertical line displayed at low frequency range further suggests an ideal capacitive behavior due to facile ion transport. More clearly, Bode plots shown in FIG. 5E compare the response times of different supercapacitors. For commercial ACs, the characteristic frequency (f₀) is in the order of 0.1-1 Hz. Remarkably, our HPG carbon devices show a high f₀ of ˜7 Hz, which corresponds to a time constant τ₀ (=VA) of only ˜0.14 s. This value is also lower than that of activated graphene (˜0.25 s), liquid-mediated dense graphene (0.51˜3.85 s) and holey graphene framework (0.17-0.49 s). The short time constant is mainly due to the 3D interconnected hierarchically porous structure, which provides fast ion transport in the bulk electrodes.

Practical application of supercapacitors requires high active mass loadings to obtain large areal capacitances. Our HPG carbon can be easily made on gram scale in powder form and high mass loading electrodes can be readily attained. Owing to the effective porous conductive structure, the HPG carbon electrodes can retain ˜83% of the initial capacitance (from 225 to 187 F g⁻¹) at 0.5 A g⁻¹ as mass loading increased from 1 to 11 mg cm², which corresponds to an areal capacitance of 2.12 F cm⁻² (FIG. 5F). The areal capacity can still be maintained as 1.62 F g⁻¹ at a current density of 2 A g⁻¹. Such high areal capacitances and high rate capability meet the requirements for commercial supercapacitors (e.g., >1 F cm⁻²). However, previously reported high-performance porous graphitic carbon electrodes could only achieve low/moderate mass loadings (<5 mg cm⁻²) or are difficult for large-scale industry manufacturing.

In addition, the HPG carbon electrodes showed a highly stable cycling performance, with capacitance retention of 96% after 10,000 cycles at 5 A g⁻¹ (FIG. 17). The EIS measurement of prototype devices before and after cycling showed little change in ESR (FIG. 18), which confirms the high electrochemical stability of our HPG carbon.

### B2d) Electrochemical Performance of HPG Carbon for Li—S Batteries

In addition to supercapacitors, the HPG carbon can enable high-performance lithium-sulfur (Li—S) batteries owing to aforementioned structure merits. One critical challenge for Li—S battery is to provide large conducting surface area for activating and trapping the insulating sulfur, lithium sulfide and polysulfide species in electrodes. While a variety of porous carbons have been used for Li—S cathodes, they often show insufficient cycling stability and/or low sulfur mass loadings (<2 mg cm⁻²) due to moderate surface area and lack of effective pore structure to keep active sulfur species and thus electrode activity. Again high mass loading could not previously be realized due to the poor conductivity of the carbon electrodes.

A schematic of the cell structure is shown in FIG. 19. Charge/discharge voltage profiles of HPG carbon/polysulfide electrodes show a characteristic two-step discharging behavior (FIG. 6A, FIG. 20A). The electrodes exhibit exceptional electrochemical activities. The initial discharge capacity (sulfur loading: 3.2 mg cm⁻²) at a rate of C/5 was ˜1270 mAh g⁻¹, approaching ˜90% of the theoretical capacity (1466 mAh g⁻¹, Li₂S₈ to Li₂S). Accordingly, the areal capacity reached a value as high as 4.2 mAh cm⁻². A capacity of 920, 740 and ˜600 mAh g⁻¹ can be delivered at rate of 0.5 C, 1 C and 2 C, respectively (FIG. 20B), indicating a high rate capability at a high mass loading. After initial equilibrium cycles, the electrodes can retain a high capacity of 980 mAh g⁻¹ after 200 cycles (˜80% of initial capacity) at C/5 (FIG. 6B). The high specific capacity attained at high mass loading can be attributed to the effective hierarchically porous conductive architecture and the doping atoms of N and O for the strong LiₓS interaction that controls the formation of lithium sulfide species and maintains high active material utilization. This performance is superior to most porous carbon-based sulfur electrodes reported so far (<3 mAh cm⁻², <200 cycles, FIG. 6C).

By comparison, control electrodes made from AC-1 (sulfur loading: 2.52 mg cm⁻²) showed low capacity (<400 mAh g⁻¹). This might be due to the low electrical conductivity and poor electrolyte wetting and diffusion in the microporous AC particles. Similarly, electrodes made from carbon black (Kejten black, S_{BET} of 1200 m² g⁻¹) also showed a low initial capacity of 890 mAh g⁻¹ even at a low sulfur loading (1.28 mg cm⁻²). Moreover, such electrodes only retained a capacity of 600 mAh g⁻¹ after 200 cycles. Their faster capacity drop can be ascribed to uncontrolled deposition of insulating sulfide species, which resulted large inactive particles and loss of electrode activity. In our HPG carbon electrodes, the ultra-high surface area and polar doping atoms (N, O) provides more active sites for lithium sulfide deposition and the interconnected framework can effectively maintain conductive pathways, thus providing high cycling stability. This is supported by EIS measurements (FIG. 21), where the ESR of HPG carbon/polysulfide remains small during cycling. It is noted that cycling stability of over 500 cycles was only reported with sulfur mass loading of <1 mg cm⁻². However, making high mass loading electrodes always results in significantly decreased lifetime. Our high sulfur mass loading HPG carbon electrodes are therefore highly promising for practical applications.

### B3) Discussion

The 3D HPG carbon framework outperforms other reported porous carbons, commercial activated carbon and other 3D porous graphenes in terms of their electrochemical charge storage capability because of their highly graphitic structure with ultra-high surface area, large pore volume and interconnected pore architecture. Even though ACs with high S_{BET} of ˜3000 m² g⁻¹ have been reported, their electrochemical capacitance and rate capability were worse. In our case, we also found that the best supercapacitive performance was not from the sample with the highest surface area. This is likely due to the more irregular pore structure that is unfavorable for mass transport. Nevertheless, our versatile synthesis approach allows high structural tunability to achieve unprecedented electrochemical performance. For carbon black, there are no pores inside carbon particles, thus the total surface area is insufficient for supercapacitor application. Moreover, their particle size is so small (<100 nm) that contact resistance is very large especially for thick electrodes. This is even worse in Li—S batteries, where insulating polysulfide deposited on particle surface can block charge-transfer pathway easily. By comparison, the HPG carbon framework is composed of 3D porous network of small graphene sheets, thus can simultaneously achieve high surface area, small carbon particle size, open pore structure and good conductivity. As a result, critical requirements are satisfied for high-performance electrodes: i) large electrode/electrolyte interface to provide a large number of active sites for redox reaction, thus enabling a high charge storage capacity, ii) efficient transport of ions and minimal electrolyte transport resistance, and iii) graphitized carbon framework that ensures high electronic conductivity for efficient charge transfer and high chemical stability. These features together enable fast kinetics and low ESR, providing high rate capability for electrodes. Therefore, this class of porous graphitic carbons holds a great promise for supercapacitors and Li—S batteries with high energy and high power density.

It is noted that a few other 3D porous graphene structures have been recently reported. For example, graphene networks can be made from templated chemical vapour deposition (CVD) process followed by etching, but large scale production using CVD remains challenging. While strutted graphene grown from a sugar blowing process can be potentially made in a large scale, its ultrahigh porosity (99.85%) and ultralow density (˜3 mg cm⁻³) make it challenging to fabricate devices with reasonable volumetric energy density.

Laser induction of commercial polymer was used to prepare 3D porous graphene, but the low surface area (S_{BET} ˜340 m² g⁻¹) limits its application for high energy electrochemical devices. By comparison, our approach is compatible with the current large-scale production method for ACs and the HPG carbon provides an ultra-high surface area with a density (˜0.47 g cm⁻³) similar to commercial ACs. With a low starting materials cost (<7-11 $/kg of HPG carbon produced, FIG. 23), our HPG carbon can be readily manufactured at large scale at low cost.

In summary, we have developed a scalable synthetic approach to prepare 3D porous graphitic carbon from conjugated polymer molecular framework by a one-step synthesis from low cost starting materials. Particularly, this methodology allows production of highly graphitic carbons with ultra-high surface area along with large pore volume and interconnected graphene-like network structures. These properties lead to exceptional electrochemical activity and high stability, with unprecedented performances in both supercapacitors and Li—S batteries. The monomer, crosslinker and oxidation agents to make the precursor polymer can be readily changed to provide a large tunability for the final carbon morphology, surface area and chemical composition. Our synthetic method also allows easy incorporation of metal, metal oxides, nitrides or carbides into the carbon framework by adding metal-containing salts during the polymerization process or using it as oxidizing agent for polymerization. Therefore, this new route of making 3D porous graphitic carbons can be adapted to prepare carbon materials with desired properties for a broad range of applications.

### B4) Supporting Information

### B4a) Experimental Section

B4a1) Synthesis of 3D HPG Carbon Framework:

In an exemplary synthesis, ammonium persulfate (0.572 g) was dissolved in 1 mL of de-ionized water (solution A). Solution B was prepared by mixing 0.458 mL of aniline, 2 mL of de-ionized water and 0.921 mL of phytic acid (50%, wt/wt in water). The A and B solutions were both cooled to 4° C. and then mixed quickly. To remove excess acid and by-products from polymerization, the resulted PANi was purified by immersing in de-ionized water for 24 hours. The PANi aerogels were prepared by freeze drying hydrogels. Finally, carbonization of samples was performed at 400˜900° C. with a ramp rate of 2° C. min⁻¹ below 600° C. and 5° C. min⁻¹ above 600° C. under nitrogen. The carbonized polymers were well mixed with 2 ml of 7 M KOH, with a mass ratio of (KOH/carbonized polymer) of 3. After evaporation of water by vacuum oven at 60° C. for 4 hours, the KOH/carbonized hydrogel mixture was heated at 800° C. at a ramp rate of 5° C. min⁻¹ and maintained at this temperature for 1 hour with a nitrogen flow of 75 sccm and a working pressure of -520 Torr. After cooling, the samples were repeatedly washed with de-ionized water until a pH value of 7 was reached. They were then dried under vacuum at 65° C. for 2 hours to generate the final 3D HPG carbon powder. The calculated overall yield is ˜30%.

B4a2) Physical and Chemical Characterization:

Scanning electron microscopy (SEM) imaging was performed using an FEI Magellan 400 XHR microscope. TEM imaging was conducted at 80 kV using a FEI Titan microscope equipped with a spherical aberration (Cₛ) corrector in the image-forming (objective) lens and a monochromator. The Cₛ coefficient was set to be approximately −10 μm. The images were acquired using an Ultrascan 1000 CCD camera. Electron energy loss spectroscopy (EELS) was performed using the same microscope with a Gatan Quantum 966 EEL spectrometer. The ratios of π* and (π*+σ*) are compared by integrating the peak area of the π* and σ* components of the energy-loss near-edge structure spectra of each carbon material using equation (1):

$${f}_{π *} = \frac{{I}^{s} π * Δ ( {E}^{u} )}{{I}^{u} π * Δ ( {E}^{s} )} \qquad ( 1 )$$

where f_{π*} is the ratio between the two π* peaks, I_{π*} is the integral of the 1s→π* transition, and ΔE is the integrated counts for the normalizing energy windows (1s→π*: 283.2-287.2 eV and 1s→σ*: 292.5-312.5 eV). The superscripts s and u denote the standard and unknown spectra, respectively. At least three different locations on each carbon sample were examined to obtain average results. The elemental composition of the surfaces was measured with XPS (PHI 5000 Versaprobe, Al KR source). Raman spectra were obtained using WiTech confocal Raman microscope which was equipped with a 532 nm NiYAG laser. Nitrogen and CO₂ sorption experiments were performed using an Autosorb iQ2 (Quantachrome Instruments) low-pressure gas sorption analyzer. Nitrogen sorption was carried out using 99.999% N₂ at 77 K. Pore size distributions (PSD) were obtained using quenched solid-state density functional theory (QSDFT) calculations with carbon model of slit, spherical and cylindrical pores. Surface area measurements were obtained by the BET method within the pressure range of P/P₀=0.05-0.25. CO₂ adsorption was performed at 273 K and the temperature was controlled by a circulating bath. CO₂ adsorption isotherms were also collected by an Autosorb iQ2 analyzer using an ultrapure grade CO₂. Micropore size distributions were calculated based upon the CO₂ adsorption isotherms using the AS1Win software by non-local density functional theory (NLDFT).
B4a3) Supercapacitor Fabrication and Testing:

To fabricate interdigital supercapacitors, an ink was prepared by dispersing HPG carbon (90 wt %) and poly(3,4-ethylenedioxythiophene) polystyrene sulfonate (10 wt %, as a conductive binder) in ethanol. To make conventional supercapacitors, slurries were formed by mixing the HPG carbon (90 wt %) and poly(vinylidene fluoride) (PVDF, 10 wt %) in N-methylpyrrolidinone (NMP). Electrodes were fabricated by coating the slurry on titanium foil or on carbon-coated Al foil and dried at 80° C. for 2 hours under vacuum. The as-formed electrodes were calendared and further dried under vacuum at 100° C. for 5 hours. The electrolyte solution was 0.5 M H₂SO₄ for aqueous cells and 1 M tetraethylammonium tetrafluoroborate (NEt₄BF₄) in propylene carbonate (PC) solution for organic cells. The specific capacitance, Cₛ (F g⁻¹), of the electrode materials was calculated from the discharge curve of galvanostatic cycles, according to C=I/(dV/dt)≈I/(ΔV/Δt), where I is the constant discharge current density, E is the cell voltage, and dV/dt is the slope of the discharge curve. The EIS tests were operated in the frequency range of 10 mHz-100 kHz with AC amplitude of 10 mV.

B4a4) Lithium-Polysulfide Electrode Fabrication and Testing:

To make carbon/polysulfide battery electrodes, a 5 M Li₂S₈ solution in 1,3-dioxolane (DOL)/1,2-dimethoxyethane (DME) (1:1 in volume) with 5 wt % of LiNO₃ was used as the active sulfur material. A freshly prepared 1 M solution of lithium bis(-trifluoromethanesulphonyl)imide in 1:1 v/v DOL/DME containing LiNO₃ (1 wt %) was used as the electrolyte. Carbon slurries were formed by mixing different carbon active materials (80 wt %) and PVDF (20 wt %) in NMP. To make working electrodes and separators, carbon slurries were coated on Al foils or Celgard 2400 separators, then subject to vacuum drying at 60° C. for 10 hr. 5 M Li₂S₈ solution was dropped onto the carbon coated Al foil electrodes and DOL/DME solvent was then evaporated in Ar-filled glovebox at room temperature. For a sulfur mass loading of 3.2 mg cm⁻², 20 μL of 5 M Li₂S₈ solution were added into carbon electrodes followed by adding electrolyte. The mass ratio between active sulfur species and HPG carbon in the whole electrodes was 3:2. A HPG carbon coated separator was put on top of a working electrode with carbon side in contact with electrodes. Lithium metal discs were used as counter electrodes and coin cells were assembled in glovebox.

### B4b) Cost Analysis

Cost analysis was performed on HPC sample and was compared to other commercially available carbon. FIG. 23 shows the cost of various types of activated carbon. Price of HPC is estimated using the raw material price of Aniline, Phytic acid, Potassium Hydroxide and Ammonium persulfate, and is accounted for the yield of the thermal annealing process. $15/kg of processing cost is added to the yield-adjusted raw material price to account for the total cost of HPC carbon production.

C) Porous Carbon from a Rationally Designed Polypyrrole

### C1) Introduction

Global annual energy-related CO₂ emission reached a record high of 31.2 gigatonnes (Gt) in 2012¹, and is expected to rise continuously given the growing energy demands and the remaining fossil fuel-dependent energy infrastructure. The mitigation of CO₂ emission has been recognized as a crucial necessity, as CO₂ is a major contributing greenhouse gas that gives rise to global warming and associated consequences, including sea level rise, significant variation in weather patterns and threats to human health and wildlife habitats. The state-of-the-art technology for CO₂ capture, aqueous amine scrubbing, is yet to be proven practical at scale due to considerable energy penalties because of the high heat capacity of water for regeneration. In contrast, porous solid adsorbents possess a number of advantages, such as relatively low regeneration energy, tunability over pore geometries and pore dimensions, as well as flexibility for heteroatom doping or surface functionalization. Hence, a number of investigations have been performed on a variety of porous solids for CO₂ capture, e.g., zeolites, metal-organic frameworks (MOFs), porous carbons, porous silica and porous polymers. Nevertheless, it remains challenging to achieve scalable adsorbents that meet all the requirements. There are usually trade-offs among desired properties, i.e., large adsorption capacity, rapid adsorption and desorption kinetics, mild regeneration conditions, and multicycle stability. For example, although chemisorbents, such as porous solid-supported amines, may achieve excellent equilibrium adsorption capacities and CO₂/N₂ selectivities through chemical reactions with CO₂, they usually require heating for regeneration with relatively long adsorption/desorption cycle turn-over times. On the other hand, conventional physisorbents, such as activated carbons and MOFs, can be regenerated with minimal energy input, yet have relatively low capacity under post-combustion conditions because of weak CO₂-sorbent interactions and competing adsorption of other flue gas components, such as N₂ and H₂O, etc.

In this work, we report the facile synthesis of a nitrogen-doped porous carbon material with hierarchical pore structure and highly active CO₂ adsorption sites. Our results indicate that this carbon material balances the trade-offs mentioned above, with promising CO₂ adsorption capacity under post-combustion conditions, i.e. record-high CO₂/N₂ selectivity among porous carbon materials, a low energy requirement for regeneration and high multicycle stability. Our porous carbon was synthesized through the co-assembly of a rationally designed pyrrole monomer and a triblock copolymer using a soft-template method, which is facile, more cost-effective and fast compared to the hard-template approach. The nitrogen functionalities of the pyrrole precursor provide adsorption sites for enhanced CO₂-sorbent interactions; therefore, no additional nitrogen source or surface functionalization is required. The rigid polypyrrole conjugated polymer structure also helps to prevent pore collapsing during carbonization of the polymeric assembly while the aromatic polymer structure facilitates the formation of a graphitic carbon structure.

The hierarchical carbon structure is inspired by natural systems, e.g., lung and leaf, which exhibit enhanced gas diffusion by having a hierarchical pore structure and a range of pore sizes. Synthesis that mimics nature to provide a hierarchical structure is desirable yet challenging. Such systems in nature usually make use of supramolecular chemistry to generate hybrid materials. Our novel synthesis allows fabrication of a hierarchical structure that mimics alveoli-type structure via soft template co-assembly approaches.

Our synthesized porous carbon (SU-MC1), with a Brunauer-Emmett-Teller (BET) specific surface area of 805 m² g⁻¹ and, micropore (d<2 nm) volume of 0.17 cm³ g⁻¹, exhibits high CO₂ adsorption capacities (298 K) of 1.0 and 3.1 mmol g⁻¹ at 0.1 and 1 bar, respectively, and an excellent CO₂/N₂ selectivity of 51:1. A carbonized polymer with low-temperature chemical activation of 500° C. yields a nitrogen-doped activated carbon (SU-MAC1) with a BET specific surface area of 759 m² g⁻¹. It shows a significant increase in the micropore volume (0.34 cm³ g⁻¹) and CO₂ adsorption capacities at 298 K (1.4 and 4.5 mmol g⁻¹ at 0.1 and 1 bar, respectively, corresponding to 40% increases compared to the highest reported values at both pressures) with a record-high CO₂/N₂ selectivity (331:1, which is an order of magnitude higher than the highest value for previously reported N-doped carbon sorbents). It is important to note that selectivity is one of the major factors that determine the economics of VSA units. This merit is of great importance as high selectivity increases the CO₂ purity and hence reduces the operational cost of a plant through the reduction of energy consumption. The porous carbon can be fully regenerated solely by inert gas purging without heating through a pressure swing adsorption/desorption process. It is stable for multiple adsorption/desorption cycles (10 cycles) without any reduction in CO₂ capacity. Furthermore, it retains 78% of CO₂ capacity under humid conditions compared to dry capacity. With the addition of acidic impurities (SO₂, NO, NO₂ and HCl), which commonly exist in the post-combustion flue gas from coal burning, it retains 53% of the dry pure CO₂ capacity. Our nitrogen-doped hierarchical porous carbon possesses a number of desirable properties that render it a promising material for post-combustion CO₂ capture.

### C2) Results and Discussion

Our hierarchical porous carbon, denoted as SU-MC1, has a combination of macro (˜1 μm), meso (˜5.6 nm) and micropores (<2 nm), which were achieved through rational design of the polymer monomer precursor and synthetic procedure. A schematic showing the synthetic process and hierarchical porous structures of the SU-MC1 material is shown in FIG. 24A. A hierarchical morphology is beneficial for the applications of CO₂ capture, since the macroscopic networks facilitate CO₂ diffusion by reducing the mass-transfer resistance with the ultramicropores beneficial for CO₂ adsorption. First, the monomer needs to be hydrophilic so that it preferentially co-assemble with the hydrophilic part of the triblock copolymer surfactant template, yet not too hydrophilic such that it stays within the aqueous phase. In addition, it cannot be too hydrophobic such that it prefers to assemble into the hydrophobic cores of the triblock copolymer micelles. For example, pyrrole monomer without any modification would assemble into the hydrophobic core and result in solid polypyrrole nanospheres instead of hollow particles. We designed a 4-(pyrrol-1-yl)butanoic acid (Py-COOH) monomer, which exhibits the desired properties of an ideal monomer for our assembly process. Its hydrophilic tail renders it partially soluble in water and into the palisade region of the micelles, yet avoiding the entire molecule assemble into the hydrophobic core. Macroporous structures of our sample are formed through electrostatic interaction and microphase separation during the formation of porous polymer networks. The mesoporous structure was generated through a co-assembly process of the monomer with the structural directing triblock copolymer. Finally, the microporous structure are created through the removal of the interpenetrating block copolymer tail into the polymer matrix and probably partly from the cleavage of the butanoic acid group.

Scanning electron microscopy (SEM) of the SU-MC1 material (FIG. 24B) shows macroporous features of the carbon framework synthesized at pH=2. This structure highly resembles the appearance of lung alveoli, with thin walls and interconnected void space. Interestingly, the macroporous structure can be simply tuned by the degree of protonation. By maintaining the pH at 1 or 3.5, a foam-like structure (FIG. 27) or a fiber-like structure were observed (FIG. 24C), respectively. This might be due to variation in the intra- and inter-molecular electrostatic interaction affecting the spatial distribution of the polymer precursors. Previously, Stejskal et al. showed that aniline oligomer polymerized to give different morphologies at different acidity and oxidant size due to different degrees of stabilization from hydrogen bonding and ionic interactions. Liao et al. also showed that protonated pyrrole monomer forms cation which self-assemble with other anions and oxidant to form different nanostructures of polypyrrole.

Transmission electron microscopic (TEM) images and the corresponding Fourier diffractograms (FIGS. 24D-E) reveal a high degree of periodicity viewed from [110] and [100] directions, further confirming the 2-dimensional hexagonal mesostructure. The periodicity of SU-MC1 was further characterized using small-angle x-ray diffraction (XRD), shown in FIG. 28. The existence of (100) and (200) peaks are clearly observed, which further supports the presence of 2-dimensional hexagonal arrays. It is worth mentioning that lowering the temperature during oxidative polymerization has great advantages in slowing down the polymerization of the pyrrole monomer, and therefore retaining the mesostructure and avoiding polymer-polymer demixing.

The chemical composition of the SU-MC1 material was measured by elemental analysis, which was found to be 3.8 wt % N and 93.3 wt % C. The nature of the nitrogen species was further investigated by X-ray photoelectron spectroscopy (XPS). The N1s core level spectra is shown in FIG. 25A, where three sub-peaks at 398.0, 399.5 and 400.8 eV can be distinguished, corresponding to pyridinic nitrogen (N-6), pyrrolic nitrogen (N-5) and quaternary nitrogen (N-Q), respectively. The quaternary nitrogen is the most stable nitrogen species under pyrolysis conditions and it represents 69% of all nitrogen species in the carbonized polymer.

The porous structures of the SU-MC1 samples were further analyzed by gas adsorption/desorption techniques. Nitrogen adsorption and desorption were performed at 77 K while carbon dioxide adsorption was carried out at 273 K. A combination of the nitrogen and carbon dioxide sorption data provide information on the pore characteristics ranging from mesopores (2 nm<d<50 nm) to ultramicropores (d<0.8 nm). The nitrogen sorption isotherms (FIG. 25B) can be classified as a type IV isotherm according to the IUPAC recommendations. The steep uptake at low relative pressures reveals the microporous features (d<2 nm) while the hysteresis at a relative pressure >0.4 indicates the existence of mesopores. The apparent specific surface area of the mesoporous carbon was 805 m² g⁻¹, which was calculated using the Brunauer-Emmett-Teller (BET) method based upon the nitrogen adsorption isotherm at relative pressures of 0.05-0.3. A total pore volume of 0.88 cm³ g⁻¹ was estimated from the nitrogen uptake at the relative pressure of 0.995. A major peak in the cumulative pore volume and pore size distribution (PSD) scan can be seen at 5.6 nm (FIG. 25C inset), corresponding to the mesoporous channels originated from the removal of the block copolymer template. Furthermore, the microporous features can be observed from the CO₂ PSD, with three major peaks at 0.35, 0.48 and 0.79 nm. The cumulative ultramicropore (d<0.8 nm) volume is 0.12 cm³ g⁻¹. It is worth noting that the ultramicropores play an important role in CO₂ capture as they largely correspond with the CO₂ adsorption capacity in carbon materials.

Given the unique features, including greatly interconnected macroscopic networks, highly ordered mesopores, considerable microporosity and abundant nitrogen functionalities, the SU-MC1 material possesses great potential in the applications of CO₂/N₂ separation. The separation performance was evaluated by the equilibrium adsorption of pure gas components including CO₂ and N₂ as well as dynamic column separation of mixed gas of CO₂ and N₂. Furthermore, other important properties, such as the isosteric heat of adsorption, selectivity and cyclablity were also investigated. At 298 K, the SU-MC1 material exhibits a high CO₂ capacity of 3.1 mmol g⁻¹ at 1 bar (FIG. 25D). As a comparison, commonly used commercial activated carbons with even higher surface areas of 1150-3150 m² g⁻¹, show lower CO₂ capacities ranging from 1.2 to 2.0 mmol g⁻¹ under identical conditions. It is worth noting that this high capacity outperforms previously reported soft-templated mesoporous carbons and hard-templated CMK-3, and is among the best capacity by nitrogen-doped mesoporous carbons. Moreover, at a CO₂ partial pressure of 0.1 bar, which is a pressure more relevant to the applications of post-combustion capture, the SU-MC1 material shows a promising capacity of 1.0 mmol g⁻¹, exceeding those by literature documented nitrogen-doped micro and mesoporous carbons. Generally, the CO₂ capacities decrease as temperature increases, suggesting the exothermic nature of the CO₂ adsorption process. Comparatively, N₂ adsorption at 298 K and 1 bar was found to be 0.46 mmol g⁻¹ (FIG. 25D), which is far smaller than that of CO₂ adsorption under identical conditions. The CO₂/N₂ selectivity was calculated by Henry's Law. First, the initial slopes of the CO₂ and N₂ adsorption isotherms at 298 K were calculated, which are 33.4 and 0.65 mmol g⁻¹ bar⁻¹ for CO₂ and N₂, respectively (FIGS. 29A-B). The ratio of these slopes was then used to obtain the CO₂/N₂ selectivity of 51:1. To the authors' knowledge, this selectivity is by far the highest among previously reported micro and mesoporous carbons in the literature. The high CO₂ initial slope could be a result of the thermodynamic driving force for CO₂ adsorption provided cooperatively by microporosity and nitrogen functionality. The strength of the interaction between CO₂ and the SU-MC1 material can be further evaluated by the isosteric heat of adsorption, which was calculated by the Clausius-Clapeyron equation based upon the CO₂ adsorption isotherms at 273, 298 and 323 K. The isosteric heat of adsorption ranges from 37.2 kJ mol⁻¹ to 24.0 kJ mol⁻¹ in a corresponding CO₂ adsorption range of 0.01-2 mmol g⁻¹ (FIG. 30). The high isosteric heat of adsorption at low CO₂ loading originates from the strong pole-pole interactions between the quadrupole of the CO₂ molecules and the polar nitrogen groups. As the CO₂ loading increases, the adsorbed CO₂ molecules occupy the active surface sites therefore weakening the interactions between the surface sites and gas-phase CO₂. Hence, the isosteric heat of adsorption decreases as CO₂ loading increases and eventually flattens out at ˜24 kJ mol⁻¹.

In order to further improve the CO₂ capture performance, chemical activation process using KOH was applied. As-synthesized poly(4-(pyrrol-1-yl)butanoic acid) composite was subjected to low temperature carbonization, followed by a weak chemical activation to generated the resulting nitrogen-doped mesoporous activated carbon, denoted as SU-MAC1. Elemental analysis using combustion method indicates nitrogen loading of 5.8 wt %. XPS characterization suggests that pyrrolic nitrogen (N-5) is the dominant nitrogen species (69.0%), along with 13.2% pyridinic nitrogen (N-6) and 17.8% nitrogen oxide (N-oxide) (FIG. 26A). Pyridonic nitrogen (N-5′), which has a similar binding energy as pyrrolic nitrogen, might also be generated through this weakly oxidative activation process. The pore characteristics were analyzed by N₂ sorption at 77 K and the isotherms are plotted in FIG. 31. SU-MAC1 shows an apparent BET specific surface area of 759 m² g⁻¹, which is slightly lower than that of SU-MC1. This can be attributed to the incomplete carbonization of the polymer composite and partial removal of the block copolymer template and butanoic acid group in the low-temperature carbonization and activation processes. This is confirmed by the diminishing N₂ hysteresis (FIG. 31) along with the absence of the intense volume peak at 5.6 nm in the N₂ PSD (FIG. 26B inset). However, the low-temperature activation allows the development of significant amounts of narrow pores while minimizing the further size enlargement of the narrow pores. From the PSDs (FIG. 26B inset) it can be seen that the differential pore volume of SU-MAC1 increases significantly compared with SU-MC1 in the pore width range of <1 nm. SU-MAC1 possesses micropore and ultramicropore volumes of 0.34 and 0.30 cm³ g⁻¹ (FIG. 26B and FIG. 40), respectively, representing 72% and 64% of its total pore volume (0.47 cm³ g⁻¹). They are 100% and 150% higher compared with those of SU-MC1, respectively.

At 298 K, the CO₂ equilibrium capacities of SU-MAC1 (FIG. 26C) (4.5 mmol g⁻¹, 1 bar; 1.4 mmol g⁻¹, 0.1 bar) exhibit 40-45% increase compared to those of SU-MC1 (3.1 mmol g⁻¹, 1 bar; 1.0 mmol g⁻¹, 0.1 bar). Furthermore, it was previously reported that pyridonic nitrogen (B.E. 399.8 eV) would be beneficial for CO₂ adsorption. The great improvement of CO₂ adsorption is a result of increased of both the amount of ultramicropore volume and preferable nitrogen species. The Henry's Law CO₂/N₂ selectivity of SU-MAC1 is found to be as high as 331:1 by the ratio of the initial slopes of the CO₂ and N₂ isotherms (FIGS. 29C-D). Two commercial carbons were selected for comparison, including CMK-3 and Maxsorb. Their gas sorption behaviors are described in FIGS. 32A-B and their textual properties are listed in FIG. 40. The CO₂ capacity of SU-MAC1 (298 K, 1 bar) is 158% and 102% higher than those of the commercial CMK-3 and Maxsorb, respectively (FIG. 33). Moreover, the CO₂/N₂ selectivity of SU-MAC1 is also significantly higher than those of CMK-3 (19:1) and Maxsorb (9:1). The exceptional CO₂ capacity of SU-MAC1 also exceeds those of previously investigated mesoporous carbons under comparable conditions with record-high CO₂/N₂ selectivity. The table given in FIG. 39 summarizes the textural properties and CO₂ capture performances of SU-MC1 and SU-MAC1 in comparison to literature reported mesoporous carbons. The CO₂ isosteric heat of adsorption of SU-MAC1 ranges from 46 to 28 kJ mol⁻¹ at CO₂ loadings of 0.01-2 mmol g⁻¹ (FIG. 30). The higher CO₂ heat of adsorption of SU-MAC1 compared with that of SU-MC1 indicates stronger sorbent-CO₂ interactions.

In addition to adsorption performance based upon pure-gas isotherms, to assess the potential of applying the sorbent in practical processes, more realistic conditions are required, i.e., competitive CO₂ adsorption with N₂ in a dynamic system. Furthermore, regenerability and stability over multiple cycles are also critical in practical applications. Therefore, dynamic column breakthrough experiments were carried out. In the experiment, a mixed gas stream of 10% (v/v) CO₂+90% (v/v) N₂ was used to approximately simulate a post-combustion flue gas (see FIG. 34 for experimental apparatus). The dynamic CO₂ capacity was calculated by the CO₂ mass balance based upon the integration of the CO₂ breakthrough curves subtracted by that of a blank experiment. At 298 K, the resulting CO₂ capacities of SU-MC1 and SU-MAC1 are 0.98 and 1.45 mmol g⁻¹, respectively. It is worth noting that the CO₂ capacities from the binary dynamic breakthrough experiments match well with those from the equilibrium measurements using pure CO₂ at 298 K and 0.1 bar (i.e., 1.0 and 1.4 mmol g⁻¹ 30 mmol g for SU-MC1 and SU-MAC1, respectively). This implies that CO₂ preferentially adsorbs onto the sorbent materials over N₂, which further confirms the high CO₂/N₂ selectivity of the materials.

Furthermore, reversibility of CO₂ adsorption was tested by the dynamic column breakthrough method. To a sample saturated with CO₂, pure N₂ was purged at 298 K until no CO₂ was detected from the effluent after 30 min. For both SU-MC1 and SU-MAC1, subsequent CO₂ adsorption suggests full recovery of the CO₂ capacity. It is important to note that this mild condition for CO₂ release is advantageous since it imposes a minimum energy penalty associated with sorbent regeneration, compared to sorbents that require considerable thermal energy input for regeneration such as amine-functionalized materials. In addition, 10 cycles of adsorption and desorption were performed. It can be seen that the CO₂ capacities of both the SU-MC1 (FIG. 35) and SU-MAC1 (FIG. 36D) materials are retained over 10 cycles except for variations due to experimental error. Hence, the SU-MC1 and SU-MAC1 materials presented here can be easily and fully regenerated over multiple cycles without noticeable reduction in CO₂ adsorption performance. In addition, at 298 K and 0.1 bar partial pressure of CO₂, the dynamic CO₂ capacities of SU-MC1 and SU-MAC1 under humid conditions (˜3 vol % water) were found to be 0.51 and 1.13 mmol g⁻¹, respectively, corresponding to 48% and 22% decreases compared to the dry CO₂ capacities (FIGS. 36A-C). These drops are much less in comparison with conventional physisorption sorbents, such as zeolite 13 X, with a capacity drop of >90% upon the introduction of water vapor, leaving a capacity of ˜0.03 mmol g⁻¹ under humid conditions comparable to this study. The smaller decrease of the SU-MAC1 CO₂ capacity compared to SU-MC1 can be attributed to stronger sorbent-CO₂ interactions as suggested by the CO₂ isosteric heat of adsorption and also the higher amount of pyrrolic and pyridonic types of nitrogen in the carbon framework. The humid CO₂ adsorption/desorption was repeated for 10 cycles on SU-MAC1 with fully regenerated CO₂ capacity between subsequent cycles (FIG. 26D), which suggests excellent stability of the material in humidity. While limited data is available on CO₂ physisorption onto porous carbons under humid condition, the humid CO₂ capacity of SU-MAC1 exceeds that of a previously reported nitrogen-containing mesoporous carbon, i.e., 0.91 mmol g⁻¹, with even slightly higher CO₂ partial pressure (0.14 bar). In addition, trace amounts of acidic impurities, i.e., 300 ppm SO₂, 100 ppm NO, 5 ppm NO₂ and 10 ppm HCl, were introduced into the 10%/90% CO₂/N₂ mixture to investigate their effects in the scenario of sub-bituminous coal combustion as shown in FIG. 37. The CO₂ capacity of SU-MAC1 was found to be 0.74 mmol g⁻¹, corresponding to a 47% decrease compared to the pure CO₂ capacity. Further investigation on improving CO₂ capacity under humid and acidic conditions is needed for physisorption sorbents; nevertheless, all of these promising properties reveal its extraordinary potential for CO₂/N₂ separation.

### C3) Conclusion

In conclusion, we have demonstrated a synthetic strategy for the fabrication of nitrogen-doped mesoporous carbon through a soft template approach, with a rationally designed nitrogen-containing monomer. The porous conjugated polymer-derived carbon possesses high specific surface area, large pore volume and hierarchical structures ranging from macro, meso, to micropores. Our hierarchical porous carbon demonstrated promising CO₂ sorption capability (1.0 and 3.1 mmol g⁻¹ at 298 K, 0.1 and 1 bar CO₂, respectively), excellent CO₂/N₂ selectivity (51:1), easy regenerability and multiple cyclability. Furthermore, the chemically-activated carbon achieved the highest specific CO₂ adsorption capacity (1.4 and 4.5 mmol g⁻¹ at 298 K, 0.1 and 1 bar CO₂, respectively) compared to previously reported mesoporous carbons with a record high CO₂/N₂ selectivity of 331:1. The material can be fully regenerated under mild conditions. It exhibited high performance under humid conditions and excellent stability in humidity. The design concept in this work can be further developed for synthesizing a hierarchical porous carbon for CO₂ capture through careful design of the nitrogen-containing polymer precursor, which leads to the co-assembly between conjugated polymer-based precursors and a surfactant soft template.

### C4) Materials and Methods

### C4a) Materials.

Two commercial porous carbon materials, i.e., Maxsorb and CMK-3, were purchased from Kansai Coke and Chemicals Co., Ltd. and ACS Material, LLC, respectively. All other chemicals and solvents were purchased from Sigma Aldrich and used without further purification.

C4b) Synthesis of 4-(Pyrrol-1-yl)butanoic acid.

The synthetic route for 4-(pyrrol-1-yl)butanoic acid was adapted from the previous work by Gracia et al. In an exemplary synthesis, 4-aminobutyric acid (10.0 g, 97 mmol), H₂O (144 ml), sodium acetate (NaOAc, 8.0 g, 97.5 mmol), acetic acid (AcOH, 48 ml) and 1,2-dichloroethane (144 ml) were heated together at 90° C. in N₂. 2,5-dimethoxytetrahydrofuran (12.6 ml, 97.2 mmol) was added to the mixture, which was vigorously at 90° C. for 16 h. The mixture was cooled, and the organic layer was removed. The aqueous layer was extracted with dichloromethane three times (CH₂Cl₂, 3×20 ml). The combined organic extracts were washed with water (2×200 ml), dried with anhydrous magnesium sulphate (MgSO₄), filtered and the solvent was removed under a reduced pressure using a rotor-yap. The crude product was dissolved in CH₂Cl₂ (20 ml) and extracted repeatedly with saturated aqueous NaHCO₃ solution. The combined basic extracts were made acidic with aqueous HCl solution and again extracted with CH₂Cl₂ (3×20 ml). The organic phase was dried (MgSO₄) and the solvent was removed under a reduced pressure to give 4-(pyrrol-1-yl)butanoic acid in 64% yield. ¹H NMR (400 MHz, CDCl₃, δ, ppm) 6.64 (t, J=2.1 Hz, ArH, 2H), 6.15 (t, J=2.1 Hz, ArH, 2H), 3.95 (t, J=6.8 Hz, NCH₂—, 2H), 2.32 (d, J=7.3 Hz, —CH₂COOH, 2H), 2.08 (q, J=6.9 Hz, —CH₂CH₂CH₂—, 2H). The ¹H NMR spectrum is shown in FIG. 38.

### C4c) Synthesis of Nitrogen-Doped Mesoporous Polymer/Mesoporous Carbon (SU-MC1).

Triblock copolymer Pluronic® P-123 is used as the soft template for the synthesis of mesoporous polypyrrole. Hydrochloric acid and an ice water bath were used to control the solution pH and temperature, respectively. Ferric chloride (FeCl₃) was added to the aqueous solution to polymerize 4-(pyrrol-1-yl)butanoic acid co-assembled with the soft template surfactant in a controlled manner as described below.

In an exemplary synthesis, Pluronic® P-123 (0.598 g, purchased from Aldrich and used as received) and ferric chloride (1.14 g) were added to a mixture of Millipore Water (15 ml) and 12 M HCl (2.5 ml) cooled with an ice water bath. The solution was vigorously mixed for 2 hours before 4-(Pyrrol-1-yl)butanoic acid was added drop-wise to the above solution. After vigorous stirring with a magnetic stirring bar for 20 minutes in air, this solution was allowed to sit without stirring in an ice water bath for 20 hours, followed by hydrothermal heating to 100° C. to complete the polymerization of the 4-(pyrrol-1-yl)butanoic acid monomers. The hydrothermal product was then filtered and washed with de-ionized water repeatedly. Carbonization was performed in a horizontal tube furnace (25-mm diameter) under N₂ (99.999%) flow of 75 sccm and a working pressure of ˜520 Ton. The polymer composite was first heated to 350° C. at a ramp rate of 1° C./min and held for three hours to slowly decompose the triblock copolymer surfactant, followed by heating to 600° C. at ramp rate of 1° C. /min and finally to 800° C. with 5° C./min and held for two hours to produce the final porous carbon (SU-MC1).

### C4d) Synthesis of Nitrogen-Doped Mesoporous Activated Carbon (SU-MAC1).

Oxidative chemical activation of a low temperature carbonized sample of SU-MC1 using potassium hydroxide (KOH) was performed to generate SU-MAC1. In an exemplary procedure, the as-synthesized poly(4-(pyrrol-1-yl)butanoic acid) composite was carbonized in a horizontal tube furnace under N₂ flow to 350° C. at a ramp rate of 1° C./min and hold for 3 hours, denoted here as SU-MC1-350° C. The powder was collected and dispersed in a 7M aqueous KOH solution using a mass ratio of 3:1 for KOH to SU-MC1-350° C. The mixture was stirred for 2 hours and dried in vacuum oven at 65° C. for 4 hours, which is then followed by heating under N₂ to 500° C. (ramping rate: 5° C.·min⁻¹, holding time: 1 h). The activated samples were then thoroughly washed three times with HCl solution (10 wt %) to remove any remaining inorganic salts and then washed extensively with deionized water until a neutral pH was measured. Finally, the activated carbon was dried in an oven at 65° C. in vacuum oven overnight. The nitrogen-doped mesoporous activated carbons thus synthesized are denoted as SU-MAC1.

### C4e) Characterization.

Scanning electron microscopy (SEM) was performed using an FEI Magellan 400 XHR microscope with a 5 kV accelerating voltage and 25 pA current. Transmission electron microscopy (TEM) investigations were performed using a 200 kV TEM FEI Tecnai T20 instrument. The elemental composition of the surfaces was measured with XPS (PHI 5000 Versaprobe, Al KR source). Elemental analysis was performed using a Carlo-Erba NA 1500 analyzer for determination of total nitrogen and carbon content of the bulk samples. ¹H NMR spectrum was recorded using Varian Inova 500 in deuterated chloroform at 293 K. N₂ and CO₂ sorption experiments were performed using an Autosorb iQ2 (Quantachrome) low-pressure gas sorption analyzer. The samples were outgassed at 0.001 torr and 200° C. for 12 hours prior to measurements. N₂ physisorption analysis was carried out using 99.999% N₂ at 77 K. The N₂ pore size distribution (PSD) was obtained using a non-local density functional theory (NLDFT) carbon model with slit and cylindrical geometries. Specific surface areas were obtained by the Brunauer-Emmett-Teller (BET) method within the relative pressure range of p/p₀=0.05-0.35. The same outgassing procedure was adapted for the CO₂ adsorption measurements. CO₂ adsorption was performed at 273, 298 and 323 K with the temperature controlled using a circulating bath. The CO₂ PSD was calculated using the NLDFT carbon model based upon the CO₂ adsorption isotherm at 273 K.

### C4f) Dynamic Column Breakthrough Experiments.

The dynamic CO₂ capacity was evaluated using a custom-built dynamic gas breakthrough system. A mixed gas of 90 vol % N₂ and 10 vol % CO₂ was obtained by regulating the flow rates of each gas with mass flow controllers. The total flow rate of the mixed gas was kept at 30 cm³ min⁻¹. The packed-bed column was a vertical stainless steel tube with an inner diameter of 0.40 cm. The sorbent sample was held on a porous stainless steel filter, which was cut to fit tightly inside the stainless steel tube. The sample size is usually within the range of 15-30 mg. The column is heated using controlled Thermolyne heating tape. The sorbent sample was heat treated at 130° C. in a helium stream for at least 6 hours prior to measurements. Regeneration was perform by purging N₂ at 25° C. for 30 min between subsequent cycles. The effluent gas was analyzed using an Extrel Max300-LG mass spectrometer. In a test under humid conditions, the N₂ stream was bubbled through a stainless steel column with water before mixing with CO₂. The bubbling process was allowed to equilibrate for at least 20 minutes prior to analysis. The water concentration in the gas stream is approximately 3 vol % assuming water saturation vapor pressure (100% humidity) at 298 K.

1. A method of forming porous carbon, the method comprising:
providing a first precursor that includes one or more aromatic monomers;
providing a second precursor;
forming a 3-D polymer network from the first precursor and the second precursor, wherein the second precursor provides cross linking of one or more polymers derived from the first precursor;
drying the 3-D polymer network to provide a dried structure; and
carbonizing the dried structure to provide a porous carbon structure, wherein carbon of the porous carbon structure is provided at least in part by carbonization of the first precursor, wherein pores of the porous carbon structure are provided at least in part by volatilization of the second precursor, and wherein volatilization of the second precursor occurs at least in part when the dried structure is partially carbonized.

2. The method of claim 1, further comprising activating the porous carbon structure to further increase porosity of the porous carbon structure.

3. The method of claim 2, wherein the activating the porous carbon structure is performed at a temperature of 1000 C or less.

4. The method of claim 1, wherein the aromatic monomers include one or more heteroatoms to provide functional groups in the porous carbon structure.

5. The method of claim 1, wherein the aromatic monomers form one or more conjugated polymers.

6. The method of claim 1, wherein the porous carbon structure is at least partly graphitic.

7. The method of claim 1, wherein the 3-D polymer network is formed via non-covalent interactions between the first precursor and the second precursor.

8. The method of claim 7, wherein the non-covalent interactions comprise one or more interactions selected from the group consisting of: hydrogen bonding, metal-ligand bonding, and ionic bonding.

9. The method of claim 1, wherein the second precursor is selected from the group consisting of: phytic acid, phytic acid derivatives, inositol phosphates, inositol phosphate derivatives, tetrakis[phenyl-4-boryl(dihydroxy)]methane and metallo or H,H-phthalocyanine-tetrasulfonic acid.

10. A method of forming porous carbon, the method comprising:
providing a first precursor having an A-B structure with one or more B groups attached to an A backbone,
wherein A is a hydrophobic aromatic monomer or a chemical combination of aromatic monomers selected from the group consisting of: pyrrole, thiazole, pyridine, aniline, thiophene, furan and their derivatives, and
wherein B is a functional group selected from the group consisting of: carboxylic acid group (—COOH), hydroxyl group (—OH), amine group (—NH2), nitrile group (—CN), sulphonic acid group (—SO3H), phosphonic acid group (—PO4H), amide group (—C(═O)—NH—), boronic acid (—BO2H2) and amino acid group (—CH(NH2)-COOH);
providing a second precursor;
forming a structured polymer from the first precursor and the second precursor, wherein a structure of the structured polymer is determined by a micelle structure formed by the second precursor, and wherein a first polymer formed by the first precursor is disposed to coat the micelle structure formed by the second precursor;
carbonizing the structured polymer to provide a porous carbon structure, wherein carbon of the porous carbon structure is provided at least in part by carbonization of the first polymer, and wherein pores of the porous carbon structure are provided at least in part by volatilization of the second precursor.

11. The method of claim 10, wherein the B groups are hydrophilic and wherein a solvent used to form the micelle structure of the second precursor is hydrophilic.

12. The method of claim 10, wherein the B groups are hydrophobic and wherein a solvent used to form the micelle structure of the second precursor is hydrophobic.

13. The method of claim 10, further comprising activating the porous carbon structure to further increase porosity of the porous carbon structure.

14. The method of claim 13, wherein the activating the porous carbon structure is performed at a temperature of 1000 C or less.

15. The method of claim 10, wherein the aromatic monomers include one or more heteroatoms to provide functional groups in the porous carbon structure.

16. The method of claim 10, wherein the aromatic monomers form conjugated polymers.

17. The method of claim 10, wherein the porous carbon structure is at least partly graphitic.
